(19) United States
(12) Patent Application Publication
(10) Pub. No.: US 2011/0218826 A1
(43) Pub. Date: Sep. 8, 2011

(54) SYSTEM AND METHOD OF ASSIGNING RESIDENTIAL HOME PRICE VOLATILITY

(75) Inventors: RYAN BIRTEL, CHARLOTTE, NC (US); MAX ANTHONY, WEDDINGTON, NC (US); FRANK MCCOLLUM, TEGA CAY, SC (US); JUSTIN STARNES, CHARLOTTE, NC (US)

(73) Assignee: LIGHTHOUSE GROUP INTERNATIONAL, LLC, Charlotte, NC (US)

(21) Appl. No.: 13/019,403

(22) Filed: Feb. 2, 2011

Related U.S. Application Data
(60) Provisional application No. 61/306,259, filed on Feb. 19, 2010.
(60) Provisional application No. 61/353,738, filed on Jun. 11, 2010.

(51) Int. Cl. G06Q 40/00; G06Q 50/00

(52) U.S. Cl. 705/4; 705/37

(57) ABSTRACT

A system and method for assigning loss of residential home value, due to systemic risks, through the creation and distribution of a financial instrument such as Home Value Assurance™ (“HVA™”). HVA™ is a process by which a capital market investor takes risk of a down-turn in national or regional real estate markets through a fully-funded index-linked note, while simultaneously providing contractual protection to consumers and institutions against drops in home prices due to the systemic pressures that drive home price index levels. The product may be sold to those who are exposed to the risk of a systemic downturn in residential home values, i.e. a singular home owner, an institution owning a portfolio of loans secured by liens on residential real property, etc.

### CROSS REFERENCE TO RELATED APPLICATIONS

This application claims priority to U.S. Provisional Patent Application Ser. No. 61/306,259, filed Feb. 19, 2010, entitled “METHOD OF ASSIGNING RESIDENTIAL HOME VALUE VOLATILITY” and U.S. Provisional Patent Application Ser. No. 61/353,738, filed Jun. 11, 2010, entitled “METHOD OF ASSIGNING CRE VALUE VOLATILITY.”

### TECHNICAL FIELD

The present disclosure relates, generally, to residential real estate risk mitigation and, more particularly, to a system and method of assigning home price volatility using a new financial instrument called Home Value Assurance™ (“HVA™”). The HVA™ system and methodology can be used further to mitigate systemic risk in other asset classes including, but not limited to, commercial real estate.

### BACKGROUND

The U.S. and World economies have recently experienced the deepest recession since the Great Depression of the 1920s. A cause of this crisis is generally credited to the collapse of the residential real estate market in the United States. The root cause of this collapse was a general lack of understanding of how to properly value residential real properties and how to govern the risks associated with fluctuations in such values.

Homebuyers and financial institutions were willing to purchase and finance homes at prices that were increasing at an accelerating rate not supported by fundamental economic principles nor sound valuation methods. The housing price phenomena can be visualized through an examination of any of the publicly available housing price indices. For example, the S&P/Case-Shiller Composite-10 Home Price Index peak value in June 2006 represented an 89% rise from just five years earlier. It took fourteen years for the same index to rise the same percentage amount prior to that five-year window, thus the 2001 through 2006 period exhibited triple the rate of increase as the historical norm. For further information on the Case-Schiller Indices, see CME Group's “S&P/Case-Shiller Home Price Indices Futures and Options,” available at http://www.cmegroup.com/trading/real-estate/files/spcaseshiller_fact_card.pdf. In retrospect, the decisions of homebuyers and financial institutions could be viewed as just a lack of critical thinking, however, one should not dismiss the environment, human behavior and financial regulations, or lack thereof, as the cornerstones to the valuation bubble and collapse.

Historical methods of assigning real estate risk currently exist in the forms of guarantees, including, for example, Government Sponsored Enterprise (“GSE”) insurance and private insurance coverage of individual mortgage loans, pools of mortgage loans and mortgage-backed securities (“MBS”). Guarantee programs such as these are focused on providing protection to the lender, or buyer of mortgages, rather than to the homeowner, who is typically the payer of protection. Payment by the homeowner may be through a monthly escrowed fee, an upfront lump sum or financed via a higher monthly mortgage loan payment. These historical methods of lender protection use an insurance model identified by small premium payments from which reserves are held against unexpected losses measured analytically as a function of individual consumer credit risk. This method does not adequately provide protection against systemic risks such as home price changes, which tend to be highly correlated across various markets, and at times will violate critical assumptions used when determining insurance premiums leading to inadequate loss reserves. Since the Great Depression, the Private Mortgage Insurance (“PMI”) business community has experienced multiple industry-wide failures. Before the Great Depression, the PMI industry was characterized as “local in character” and mortgage lending was generally not supervised by the federal government, thus intervention was rare. In 1933, under the weight of loan default rates hitting 50% and foreclosures exceeding 1,000 per day, the existing private mortgage insurance industry failed. For further information on the PMI industry and Federal Housing Administration (“FHA”), see Pennington-Cross, Anthony and Anthony M. Yezer (2001), “The FHA in the New Millennium,” Center for Economic Research Discussion Paper No. 01-02, 3. By 1934, there were no mortgage insurance companies in existence. After the failure of the banking industry, private mortgage markets and PMI, the FHA was created under the National Housing Act of 1934 for the purpose of standardizing lending practices and providing the necessary public mortgage insurance to reinvigorate the languishing housing sector. With a post-war housing boom and a period of relative home price stability, private mortgage insurers began to re-surface in 1957 and by 1981, there were 15 PMI companies in the United States. However, in the 1980s, the housing market experienced another significant crash and with it, many PMI companies declared bankruptcy and stopped writing new business. For further information on the history of PMI companies, see “History of Mortgage Finance with an Emphasis on Mortgage Insurance” by Thomas N. Herzog, PH.D., ASA, Society of Actuaries, 1 (2009). In 2009, the industry found itself in trouble again with $20 billion in claims to support lender clients. A massive recapitalization effort from the GSEs was required to enable PMI companies to remain solvent and continue writing policies, with the federal government and FHA again being required to support the housing market.

Given potential regulatory changes in housing finance, and a continued challenging housing market, the future for the PMI industry remains uncertain. What is certain is that, without innovations in risk assessment methods, the housing finance market will continue to repeat the experiences surrounding previous real estate down cycles. When looking at the 120-year history of home prices adjusted for inflation presented by Robert Shiller's Index of American Housing (see, e.g., “Irrational Exuberance,” 2nd Edition, 2006, Robert J. Shiller), since 1900, housing market crashes (defined as low points) have occurred in, for example, 1921, 1932, 1942, 1984, 1998 and the current (˜2008-2011) cycle; each of these crashes stresses, and makes transparent, the PMI's inability to protect against systemic declines in home prices. For further information on the history of home values, see Robert Shiller's “Irrational Exuberance,” 2nd Edition, 2006 and chart, available at http://graphics8.nytimes.com/images/2006/08/26/weekinreview/27leon_graph2.large.gif.

Other methods of assigning real estate risk include credit-tranching within MBS and credit-linked notes, where payment rules direct various levels of credit risk to various debt and equity positions of the corporate capital structures, each with various coupons and yields to investors as compensation for differing risks.

In recent decades, a number of efforts have been made to create a product to help consumers and institutions hedge themselves against undesirable home valuation risk. Quasi-municipality supported efforts were executed in the 1980s and 1990s in Chicago, Ill., Oak Brook, Ill., and Syracuse, N.Y. All three of these efforts received some amount of public backing and were used to solve a very specific problem of neighborhoods experiencing urban blight. The programs typically received most of the funding from the municipality, and would in turn guarantee homeowners the current values of their homes so long as they remained in the homes and made improvements and maintained the properties to some set standard. The goal was to put a floor on values in the specific neighborhoods and alleviate concerns over home values. However, all of these programs used small insurance reserves as protection against home price declines that proved to be inadequate coverage during the real estate downturns of the 1980s and 1990s where home prices in the referenced neighborhoods experienced highly correlated price performance that violated the standard insurance actuarial model predictions.

Property derivatives as risk mitigates have been studied and attempted since the early 1990s in both the U.S. and U.K., however those attempts have typically resulted in outright failure or very limited utility. The common forms of derivatives (e.g., Forwards, Swaps and Options) were all viewed as viable instruments to apply to the property market as they, in theory, may provide very customizable investment and hedging strategies; however, the practical implementation of them has proven to be a failure. For example, in the United States, Dr. Robert Shiller has supported the futures (exchange-traded forwards) and options market to hedge home prices using the various national and Metropolitan Statistical Area (“MSA”) level S&P/Case-Shiller indices that are in existence. However, forwards and swaps (a series of forward contracts) instruments that allow two parties to exchange monies at a future date based on the performance of a reference index, proved impractical for direct consumer and small institutional usage due to the complexity and expense of managing clearing exchange margin requirements while calibrating and maintaining appropriate hedge ratios. Larger institutions that have the expertise and income to handle such technical and expense aspects were not able to participate on a large scale simply due to the counterparty risk inherent in these “promise to pay” instruments. Options to enter into forward contracts, though suffering from counterparty risk and complexity as well, thus limiting their use to smaller institutions and consumers, have the added handicap of relying heavily on the existence of an active and high volume forward market such that standard pricing methodologies can be applied. Without the active forward market, the potential user of options can not satisfy the mark-to-market (valuation) mandates. With these handicaps, the actual market that could, and did, use these instruments is but a tiny subset of the total market involved in real estate. A hybrid derivative, called a structured note, does provide one side of the transaction, the note seller, with some relief from counterparty risk in that a portion, or all, of the note balance is paid by the note buyer upfront. However, this instrument has all of the pricing weaknesses of the standard derivative embedded within it, plus the counterparty weakness for the note buyer.

In an attempt to remedy these shortcomings, Shiller engaged MacroMarkets to create two exchange traded funds (“ETFs”) to track the upward and downward movements in home prices using MacroMarkets' proprietary index-linked security technology, called MacroShares. It was perceived that the existence of a tradable ETF security would increase the viability, and thus restart the development, of the earlier attempted futures and option market. To alleviate counterparty concerns, these funds utilized the concept of full-funding and indeed mandated such funding be invested in U.S. Treasury-grade collateral securities. However, as will be discussed in greater detail below, other structural features led to the shuttering of both funds in the first year of existence. Such features embedded market and reinvestment risks in addition to creating a limit to the natural customer base, thus capping the funds' own utility and ultimately failing to achieve the goal of becoming the basis of an improved futures and option market. The failures of this and related derivative products to simultaneously identify and isolate real estate price risk for the largest real estate investor markets is the driving force for the innovation of the herein-described HVA™ process. For additional information on home equity insurance, MacroShares, and the failure of MacroShares, refer to Robert J. Shiller and Allan N. Weiss's paper entitled “Home Equity Insurance, Working Paper No. 4830,” published August 1994 by the National Bureau of Economic Research; Michael Johnston's article entitled “MacroShares Shutters UMM, DMM,” published Dec. 28, 2009 (available at http://etfdb.com/2009/MacroShares-shutters-umm-dmm/); and Christopher M. Wright's article entitled “Capital Markets: Robert Shiller, Arthur M. Okun Professor of Economics, Yale University”, REIT Magazine, May-June 2010.

Despite all of these efforts, there is still a need for a financial instrument that properly transfers losses in residential home value due to systemic risks while removing the underfunded counterparty risk that has plagued all prior attempts to do so. For example, the Mar. 9, 2009 article entitled “AIG Told U.S. Failure May Cripple Banks, Money Funds” (http://www.bloomberg.com/apps/news?pid=newsarchive&sid=a72q7hFPu5Cs&refer=home, accessed Oct. 31, 2010) demonstrates the global impact stemming from underfunded counterparty risk. The article states that “AIG warned of turmoil around the globe if the government allowed the insurer to fail, adding ‘it is questionable whether the economy could tolerate another shock to the system that a failure of AIG would produce.’ The value of the U.S. dollar might fall, Treasury borrowing costs could rise and the agency would face ‘doubts about the ability of the U.S. to support its banking system,’ according to the presentation, parts of which were reported earlier by the New York Times. The municipal bond market would be stressed and Boeing Co. could lay off workers if AIG's plane-leasing unit folded, the company said.”

To avoid the collapse of major institutions that have large exposures to real estate risk (e.g., PMI companies, GSEs, Banks, AIG, etc.), one must first study the most influential drivers of risk to real estate-related investments, home values and credit. Although both home values and credit are themselves driven by factors that can be decomposed into two segments, systemic and specific, home values are driven primarily by systemic pressures and credit by the specific pressures. The specific factors affecting real estate investments are less correlated and best dealt with through the classic methods of guarantees (e.g., mortgage insurance, property/catastrophe insurance, etc.), credit underwriting (consumer and institutional) and credit subordination (e.g., tranching—creating securities offered as part of a same transaction in a senior—subordinate relationship), which are effective in managing and pricing such risk using classic actuarial methods. However, the systemic risk inherent to real estate investments, via highly correlated home values, requires a separate framework (e.g., HVA™) to transfer. Such a framework makes transparent, tracks and is structured to withstand both the large relative swings and long price cycle of real estate. For instance, there are a number of existing indices that may be used in conjunction with a separate frame work and track home prices with very defined procedures. A notable index is the Standard & Poor (“S&P”) Case-Shiller Index, which tracks a number of MSA and regional residential home prices. The Case-Shiller Home Price Indices are constant-quality house price indices for the United States (including, for example, a national home price index, a 20-city composite index, a 10-city composite index, and twenty individual metro area indices) and are calculated from data on repeat sales of single-family homes. Although the S & P Case-Shiller Home Price Indices are useful, an HVA™ protection buyer may choose to rely on another index or none at all.

Attempts of remedying and/or avoiding the above-mentioned tribulations are taught by a number of U.S. patent applications to McGill et al. (collectively, “McGill”), including: U.S. Patent Publication No. 2006/0080228, published Apr. 13, 2006; U.S. Patent Publication No. 2005/0075961, published Apr. 7, 2005; U.S. Patent Publication No. 2006/0248000, published Nov. 2, 2006; U.S. Patent Publication No. 2006/0248001, published Nov. 2, 2006; and U.S. Patent Publication No. 2007/0156563, published Jul. 5, 2007.

The McGill applications teach a method for creating, marketing and selling a contractual instrument for protecting a value characteristic of a homeowner's residential real estate property. The McGill derivative instrument is created in the form of a simple contract like a “Home Equity Protection Product” (“HEP”) sold to the homeowner by a mortgage originator or Property and Casualty (“P&C”) insurer. The Home Equity Protection Product provides a cash-settled payout to the buyer at a predetermined expiration date defined by the contract correlated to, e.g., the home's market value or home equity value, and a reduction in value of a benchmark real estate index between, e.g., the contract purchase date and the expiration date. The Home Equity Protection Contracts may be securitized much like mortgage-backed securities on a secondary market and sold to institutional investors to permit them to speculate in the value of residential real estate in order to broaden their investment portfolios.

There are, however, crucial deficiencies in the Home Equity Protection Product taught by McGill. The majority of the deficiencies generally relate to a lack of protection awarded to the seller of the protection and/or the lack of available funding.

For example, in McGill, a premium payment from the protection buyer is paid as an additional fee each month as part of the mortgage payment to purchase HEP. This payment arrangement puts the seller of the protection at risk of consumer or institutional creditworthiness. The HVA™ system taught in the present disclosure remedies this by including an HVA™ trust (e.g., a trust account) that may receive one upfront premium payment for the term of the protection from either the protection buyer or an intermediary on behalf of the protection buyer. This element is important in that the HVA™ process isolates the seller of protection from consumer and institutional credit risk.

Similarly, another deficiency is the lack of protection provided to the sellers of the protection. McGill teaches that the HEP may be securitized much like mortgage-backed securities on a secondary market and sold to institutional investors to permit them to speculate in the value of residential real estate in order to broaden their investment portfolios. The HVA™ trust may securitize the contracts, but sells only the residential real estate value risk to institutional investors, not the credit risk inherent in other investments that rely upon future payments from a non-sovereign entity. It is important that the HVA™ process isolates the seller of protection from consumer and institutional credit risk.

McGill also teaches that the Preferred Index for use in association with the residential real estate derivatives of the present invention is the “American Housing Survey” compiled and issued by U.S. Department of Housing and Urban Development (“HUD”). However, the “American Housing Survey” is not robust enough to provide the best representation of changes in real estate valuation. The HVA™ system looks to capture, as accurately as possible, the best representation of changes in real estate valuation due to time, and thus may reference various other price indices which utilize greater and more frequent data along with differing construction methodologies, such as the paired-sale methodology (e.g., the Case-Shiller Indices and Federal Housing Finance Agency (“FHFA”) Indices).

Another limitation of McGill is the teaching that the logical expiration point would be the home owner's final mortgage payment date, and/or any time at which the buyer of the HEP sells the home, since it is at this point that he would truly suffer from any depreciation in the value of the property. Although this would seem favorable to the home owner, the ability to cancel or cash out the policy at any time would create volatility for the investor and would require commensurate compensation from the homeowner. As a result, the HVA™ system would facilitate protection for a fixed length of time. The ability of the protection buyer to terminate coverage at random points in time creates what is commonly termed “prepayment” and “reinvestment” risks to the institutional investor. The HVA™ system isolates Home Price Risk from Prepayment & Reinvestment Risk and sells only the Home Price Risk to investors.

McGill further teaches that the value of HEP should be indexed for inflation, as measured by a cost of living index like the Consumer Price Index. Contrary to the McGill teachings, the HVA™ system should not need to incorporate an inflation adjusting mechanism. Inflation has a positive impact on nominal home values, thus buyers of protection who directly or indirectly have exposure to real estate are not exposed to inflation risk and any such risk to the sellers of protection investment return may be more efficiently hedged through classic methods available to the marketplace. The over-the-counter and exchange-traded derivatives markets supply these tools to fixed income investors. (e.g., Interest rate caps, Treasury Inflation Protected Security (TIPS) swaps, CPI-LIBOR basis swaps, etc.)

McGill teaches that by purchasing securitized HEPs, the institutional investors are effectively transferring home price risk from average citizens to themselves, much as they currently do for home mortgages. McGill alleges that by further supporting the home equity market, they would be providing a valuable societal benefit. Unfortunately, while McGill describes a general process of moving home price risk, McGill is devoid of necessary and sufficient features specific to HVA™ that create a unique and commercially viable securitization process. For example, the HVA™ system facilitates true transference of home price risk from a home seller to an HVA™ Note investor by isolating non-home price risks from both the home buyer and home seller. The fully-funded protection reserve protects other home buyers (i.e., society) from the absolute failure of the leveraged insurance reserve model application in the real estate industry. Therefore, a protection buyer will not need to be concerned about the creditworthiness of the institution or entity promising payment at the end of the contract term, as all potential liabilities will be fully-funded from the moment the contract is entered. Sellers of protection will have access to an investment that bears current interest as, for example, at a stated coupon that matures at a point in time, is devoid of credit and prepayment risks and is more transparent than all other real estate-related security investments. Alternatively, another option is an HVA™ Note with a variable coupon stated as a margin plus an index. This option may require the existence of collateral securities that match the maturity profile of the desired HVA™ Note, earn an interest rate that is directly variable to the same reference index as the variable rate HVA™ Note and/or exhibit the necessary “risk-free” interest and principal profile.

Another attempt of remedying and/or avoiding the above-mentioned tribulations is taught by U.S. Patent Publication No. 2003/0110111, published Jun. 12, 2003 by Nalebuff et al. (“Nalebuff”). Akin to McGill, Nalebuff teaches a financial product and associated data processing system provide risk abatement to purchasers and/or owners of real estate and/or other assets that are financed and are subject to market valuation changes. The Nalebuff product includes application of a time-dependent property index value for adjusting a future payment associated with said property, such as mortgage debt repayment, in response to declining property values. The Nalebuff system allegedly permits enhanced and expanded lending in targeted neighborhoods on a selected basis.

As in the McGill applications, Nalebuff also lacks the fundamentals required to facilitate true transference of home price risk from a home seller to an HVA™ Note investor where a fully-funded protection reserve protects the buyer from the absolute failure of the under-funded insurance reserve model application in the real estate industry.

As previously mentioned, an unsuccessful attempt of remedying and/or avoiding the above-mentioned tribulations was taught by MacroShares. MacroMarkets developed and filed patents for a product called MacroShares; see, for example, U.S. Pat. Nos. 5,987,435, 6,513,020, 2002/0194099 and 2008/0027847 (collectively, “MacroMarkets IP”). The MacroMarkets IP discusses MacroShares, an index-linked security technology that attempts to deliver the returns (or inverse returns) of asset classes and economic interests. However, MacroShares references an “Adjusted Price Index Value” (i.e., they track a multiple of the price index), whereas HVA™ may simply use the reported, unadjusted index price. The use of an index “multiple” was an attempt to create higher yields for investors within a fully-funded construct. However, the use of such index multiple only creates instability in the fund's maturity and thus the maturity and return to investors is only stable/predictable within a narrow band of index values, i.e., a stable market. Contrary to MacroShares, HVA™ is structured to allow for custom selection of maturities, attachment and detachment points such that desired investor yields can be achieved within the investor's future market outlook. MacroShares fund's values, and payouts, are dependent on current price index values, due to early termination features discussed above and below, whereas HVA™ payouts are affected by only the terminal value of the referenced index at note/contract maturity, in relation to the origination value of the referenced index. MacroShares creates complexity for investor's initial pricing exercises, in addition to the maturity instability.

MacroShares and HVA™ are both fully-funded, however, MacroShares requires both buyer and seller to contribute equal amounts of capital, a 1-to-1 ratio, at origination whereas HVA™ is structured such that the ratio of buyer to seller contribution adjusts according to buyer/seller sentiments of the risk/reward balance in any selection of index, attachment and detachment points. For example, if Freddie Mac requires $1 B of protection from a catastrophic drop in home prices, the HVA™ Note investor requires, for example, only approximately $150 Million from Freddie Mac, whereas a MacroShares “Up” investor would require $1B from Freddie Mac. This structural feature prevents the vast majority of the $16.5 trillion dollar residential real estate investment/lending market from using MacroShares as a hedging instrument, thus there is little to no use for it. MacroShares housing funds unwound with only $20 Million invested, failing to meet its $50 Million minimum size requirement. Although plausible on its face, as discussed below, MacroShares contains a number of maturity limitations.

First of all, although MacroShares uses Treasury-grade collateral securities, the collateral securities are mandated short-term (i.e., shorter than the stated maturity of the funds), thus the fund's ultimate return cannot be stated at the forefront as short-term reinvestment rates fluctuate. Secondly, HVA™ uses collateral securities that are maturity matched to that of the HVA™ Note. MacroShares securities have 5-20 year maturities that are subject to early termination due to extreme movements in the referenced indices (as demonstrated by the MacroShares-Oil funds where a bankruptcy of one of the two paired funds caused a total fund termination), and have above-mentioned volume restrictions mentioned.

Fortunately, HVA™ has an established unwavering maturity that promotes for more accurate assessment of reference index risk and pricing of such. In addition, the stable maturity allows HVA™ Note investors to address their specific concerns (outside of the HVA™ process) of interest rate risks, inflation risks, etc. which cannot be done efficiently with an investment in the MacroShares securities.

A key deficiency is that MacroShares securities do not isolate home price risk and embed tremendous market risk making them unsuitable for use by the larger real estate market as a whole. Only the HVA™ securitization system isolates the identified real estate risk from the credit, reinvestment and under-funded counterparty risks that have plagued other forms of real estate securitization and are perpetuated by prior art (e.g., McGill, Nalebuff and MacroShares). The isolation may be achieved, inter alia, by mandating a transaction be fully funded by both sides of the transaction, i.e., the HVA™ Contract Buyer contributes the cash required to cover the protection coverage amount and the HVA™ Note Investor contributes the cash required to cover seller yield requirements (and transaction costs) at the transaction closing. Such closing funds being held in, for example, U.S. Government securities for the life of the transaction is an acceptable definition of risk-free counterparty.

This isolation is one of the exclusive elements that makes the below-described embodiments useful in today's marketplace, a marketplace that is currently experiencing severe disruptions in the real estate, credit and conventional risk transfer processes through the fixed income and derivative markets that remind participants of lessons learned during the Great Depression regarding the mispricing of credit risks associated with large financial institutions and individual consumers. Although the derivatives market is the common access point for protection buyers and sellers of all asset classes to express their financial exposures directly or indirectly, the structural short comings and interdependence of participants creates tremendous systemic risk capable of crippling the entire financial system. These risks (e.g., counterparty, collateral, pricing, opaqueness, complexity, etc.) are each addressed by the HVA™ process.

As discussed above, there is a need for a protection plan that requires an upfront premium payment for term protection, from either the protection buyer or an intermediary on behalf of the protection buyer, that sells only the residential real estate value risk to institutional investors (not the credit risk inherent in other investments that rely upon future payments from a non-sovereign entity), refers to an index that provides the best representation of changes in real estate valuation due to time (as determined by the buyer of protection), facilitates protection for a fixed length of time, does not incorporate an inflation adjusting mechanism, and facilitates true transference of home price risk from a home seller to an HVA™ Note buyer (investor) by isolating non-home price risks from both the home buyer and home seller.

### SUMMARY OF THE INVENTION

The present application discloses a system and method for assigning loss of residential home value due to systemic risks, through the creation and distribution of a financial instrument such as Home Value Assurance™ (HVA™). HVA™ is a process by which a capital market investor accepts the risk of a downturn in national, or regional, real estate markets through a fully-funded index-linked note, while simultaneously providing contractual protection to consumers and institutions against drops in home prices due to the systemic pressures that drive home price index levels. The HVA™ system may be provided (e.g., given or sold) to those who are exposed to the risk of a systemic downturn in residential home values, i.e., a singular home owner, an institution owning a portfolio of loans secured by liens on residential real property, institutional investment manager, portfolio manager, insurance company, etc. The HVA™ instrument may provide for a cash-settled payment to the buyer of protection at a fixed maturity date decided at origination. Payment to the buyer may be defined by the movements of the referenced benchmark real estate index between the instrument's origination and maturity dates as it relates to the scope of protection defined by the instrument at origination. All potential payment liabilities to the buyer of protection are preferably fully-funded at the origination date by the seller of protection.

The HVA™ system is capable of immediately protecting new and existing homeowners, as well as their lenders and insurers. In time, HVA™ aims to stabilize the real estate market by reducing the severity and pace of declines in property values while establishing a mechanism for reducing volatility in future rising and falling price cycles. The HVA™ system can accomplish this by, for example, attracting private capital to the asset class of housing, setting the private mortgage securitization market in motion, enabling banks to lend again, while increasing consumer confidence. Further, the HVA™ system may be enabled such that it reduces potential burdens on the taxpayer and is a necessary tool that provides a market-based method of fairly valuing the Government's guarantees provided to the GSEs (e.g., Fannie Mae and Freddie Mac). As the HVA™ system and associated market develops, it will become the early warning mechanism that provides an alert for peak housing prices and removes the potential for the boom-to-bust cycles to which housing has been subject. The HVA™ system also assists participants obtain home financing by attracting private capital via a market based system to value risk of housing and value government guarantee fee. This configuration prevents the development of housing market bubbles by providing a much needed early indication mechanism.

Another benefit is that the full amount of the HVA™ Coverage may be held in a custodial account or trust account, as will the protection buyer's premium payment, and invested in low-principal risk investments such as U.S. Treasuries, called the collateral securities. The buyer and seller of protection will receive predetermined cash flows of either interest, principal, or both, from the custodian sourced from the interest and principal amortization of the held collateral securities.

Generally speaking, the HVA™ system securitizes HVA™ contracts and sells only the residential real estate value risk to institutional investors, not the credit risk inherent in other investments that rely upon future payments from a non-sovereign entity. Institutional investors may then purchase the systemic home price risk as defined by the terms of the Contracts in the form of HVA™ Notes. As a result, the HVA™ system isolates Home Price Risk from Credit Risk and sells only the Home Price Risk to investors.

The HVA™ system aims to capture, as accurately as possible, the best representation of changes in real estate valuation due solely to time and thus may reference various indices that utilize differing amounts and sources of data (e.g., appraisals, sales, surveys, etc.) and differing construction methods (e.g., the paired-sale methodology of the S&P Case-Shiller and FHFA Indices). Indices may be chosen, or constructed, by protection buyers such that the index performance is relevant to buyer real estate exposure.

HVA™ typically facilitates protection for a fixed length of time and, to sustain a secondary market, typically will not include the ability of the protection buyer to terminate coverage at random points in time, creating what is commonly termed “prepayment” and “reinvestment” risk to the institutional investor. The HVA™ contract may be assigned or carried with the buyer of protection, regardless of current status as the loan portfolio, security or individual home owner, but it cannot be linked directly to a final mortgage payment or a sale of the home. The fixed term facilitates demand by the ultimate seller of protection, which may be able to better price the investment, by removing both interest rate risk and specific risk to the seller of protection (e.g., to couple the sale of the house with the contract maturity adds specific risk and early liquidation of collateral securities to cover protection payments and principal payments creates interest rate-driven market risk).

The HVA™ System may further include the option of incorporating an inflation adjusting mechanism; however, this is not necessary because as inflation increases the nominal home value, any deflation would be captured by any downward trending in the S&P Case-Shiller index (or other comparable index), proving the protection buyer is already immunized from such risk. Inclusion of such mechanisms to protection seller concerns over inflation may serve to only add complexity and inefficiency to the pricing process as non-real estate risk would be incorporated in the HVA™ system. The fixed maturity profile of the HVA™ system and the existence of separate market-based inflation hedging techniques allow protection sellers to most efficiently hedge outside of the HVA™ system. For example, a seller of real estate protection can hedge concerns over deflation by selling short the inflation component of Treasury Inflation-Protected Securities (“TIPS”) or by entering into Consumer Price Index (“CPI”) linked basis swap agreements (e.g., receive CPI and pay London Interbank Offered Rate (“LIBOR”)). Otherwise, inflation is typically beneficial to sellers of real estate protection via HVA™ Notes.

However, a seller of protection receiving a fixed coupon from the trust may desire to hedge itself from rising interest rates or inflationary pressures outside of the HVA™ trust; the fixed maturity and riskless interest payment make doing so extremely cheap/efficient. It is feasible that the HVA™ system hold risk-free variable rate securities that are indexed against an index (e.g., inflation indices or indices against which the Note investor would like the HVA Note to float). However, such collateral securities should conform to the maturity profile of the HVA Note to avoid reinvestment/market risk and the HVA Note's stated coupon must be computed as a margin over the index driving the variable coupon of the collateral securities.

The HVA™ system facilitates true transference of home price risk from a home seller to an HVA™ Note investor buyer by isolating non-home price risks from both the home buyer and home seller. The fully-funded HVA™ system hedges the buyer of protection, and indirectly society, from the absolute failure of the leveraged insurance reserve model application in the real estate industry. Thus, the protection buyer should not be concerned with the credit-worthiness of the institution or entity promising payment at the end of the HVA™ contract term, referred to as counterparty risk, as all potential liabilities will be fully-funded from the moment the contract is entered. HVA™ Note Investors will have access to an investment that bears current interest as a coupon (e.g., a stated coupon that matures at a fixed point in time or a variable coupon stated as a margin plus an index), and is more transparent than all other real estate-related security investments.

The present application is also applicable to any market wherein a Price Value Assurance (“PVA”) product is desired to hedge parties against the systemic risk of fluctuations in asset value, for example, in non-real estate markets. An example of a PVA application can be found in the corporate lending market. Corporate loans are often made, then subsequently pooled with other corporate loans which are usually securitized in the private, Collateralized Loan Obligation (“CLO”) market. Securitization of corporate loans in this market may be advantageous for all parties involved in the transaction as the originating lender gains access to more capital to lend, the capital market investors gain exposure to what may be otherwise an illiquid and inaccessible market and individual corporate borrowers achieve lower financing costs that are a result of the lower yield demands of capital market investors taking risk to highly diversified pools as opposed to individual corporate entities. The PVA process can be utilized to protect CLO trusts from systemic risks such that CLO portfolio managers and investors can focus more effort on managing the specific risks with each corporate entity in the pool of loans. Such PVA hedging strategies combined with additional specific risk focus lead to greater certainty in CLO bond performance leading to greater economic efficiency extracted from the CLO securitization process. With greater efficiency comes lower corporate financing rates, more investor capital and more capital lending. Additional example of a PVA application can be found in the physical commodities market and/or interest rates market.

According to a first aspect of the present invention, a custodial server system and method are provided for a Home Value Assurance™ (HVA™) system including at least one custodial server configured to: (i) at an HVA contract initiation, receive on behalf of an HVA contract owner a full-term, fully-funded contract premium payment corresponding to a value of the HVA contract owner's home; (ii) at the HVA contract initiation, receive from an HVA note investor a fully-funded investor principal corresponding to the value of the HVA contact owner's home; (iii) after the HVA contract initiation, provide to said HVA note investor periodic interest; (iv) at HVA contract maturity, provide to said HVA contract owner a value corresponding to a change in one or more predetermined real estate indices; and (v) at HVA contract maturity, provide to said HVA note investor a value corresponding to the change in one or more predetermined real estate indices.

According to a second aspect of the present invention, a method for providing home value assurance comprises providing at least one custodial server configured to perform the steps: (i) at an HVA contract initiation, a custodian who holds the trust account receives on behalf of an HVA contract owner a full-term, fully-funded contract premium payment corresponding to a value of the HVA contact owner's desired protection coverage; (ii) at the HVA contract initiation, a custodian who holds the trust account receives from an HVA note investor a fully-funded investor principal corresponding to the value of the HVA contact owner's desired protection coverage and other predefined parameters; (iii) after the HVA contract initiation, a custodian who holds the trust account provides to said HVA note investor predefined contractual payments; (iv) at HVA contract maturity, a custodian who holds the trust account provides to said HVA contract owner a value corresponding to a change according to the predefined contract parameters in one or more predetermined real estate indices; and (v) at HVA contract maturity, provides to said HVA note investor a value corresponding to the change in one or more predetermined real estate indices.

According to a third aspect of the present invention, a method for creating and trading a fully-funded home-value security contract for real estate property comprises (i) one or more note investors selling a fully-funded home-value security contract to a contract owner who may be seeking protection from a decrease in real estate value; (ii) a custodian holding in a trust account and disbursing funds between one or more contract owners and the one or more note investors, wherein fully-funded upfront premium payments come from the one or more contract owners, either directly or indirectly; and (iii) an exchange marketplace trading the home-value security contracts.

According to a fourth aspect of the present invention, a method for providing a real estate financial instrument comprises the steps of: (i) accessing at least one real estate index that provides one or more values of one or more real estate properties; (ii) establishing a real estate instrument having a first value at a first time and another value at a fixed expiration date of said real estate instrument; (iii) defining a cash-settled payout of said real estate instrument, based upon a change in the value of the index between the first time and the fixed maturity date; (iv) indentifying a seller of the real estate instrument; (iv) indentifying a buyer of the real estate instrument; (v) marketing the real estate instrument to the seller and the buyer; (vi) selling the real estate instrument through a distribution channel; (vii) clearing and executing the transaction for the real estate instrument through a marketplace structure; and (viii) settling the real estate instrument by making the cash-settled payout to the buyer based upon any change that has occurred in at least one real estate index between two dates, the first of which is on or around the transaction issuance date, the second of which is on or around the transaction maturity date.

For this application the following terms and definitions shall apply:

The terms “communicate” and “communicating” as used herein include both conveying data from a source to a destination and delivering data to a communications medium, system, channel, network, device, wire, cable, fiber, circuit and/or link to be conveyed to a destination, and the term “communication” as used herein means data so conveyed or delivered. The term “communications” as used herein includes one or more of a communications medium, system, channel, network, device, wire, cable, fiber, circuit and link.

The term “database” as used herein means an organized body of related data, regardless of the manner in which the data or the organized body thereof is represented. For example, the organized body of related data may be in the form of one or more of a table, a map, a grid, a packet, a datagram, a frame, a file, an e-mail, a message, a document, a report, a list or in any other form.

The term “network” as used herein includes both networks and inter-networks of all kinds, including the Internet, and is not limited to any particular network or inter-network.

The term “processor” as used herein means processing devices, apparatus, programs, circuits, components, systems and subsystems, whether implemented in hardware, tangibly embodied software or both, and whether or not programmable. The term “processor” as used herein includes, but is not limited to, one or more computers, hardwired circuits, signal modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities and combinations of any of the foregoing.

The term “attachment point” (also referred to as attachment or attaches at %) as used herein means the amount of index decline in which protection coverage begins for the protection buyer. It is most often stated in percentage (%) terms. In the case of the HVA™ System, the attachment point is the point at which an HVA™ Contract owner's protection starts. It also marks the point at which the decline in the index will begin to erode the HVA™ Note investor's principal.

The term “detachment point” (also referred to as detachment or dettaches at %) as used herein means the amount of index decline in which protection coverage ends for the protection buyer. Like the attachment point, it is also stated most often in percentage (%) terms. In the case of the HVA™ System, the detachment point is the point of the HVA™ Contract owner's maximum protection. It also marks the point at which the decline in the index will eliminate the HVA™ Note investor's principal.

The term “HVA™ system” (also referred to as HVA™ or “HVA™ process”) as used herein means the securitization method through which systemic residential real estate price risk (also referred to as home value risk) is transferred from protection buyers to protection sellers via the fully-funded, counterparty risk-free structure summarized herein.

The term “HVA™ Contract” (also referred to as the “Contract”) as used herein is the agreement that protection buyers buy to hedge systemic home price risk. Contract owners may also sell or trade the Contracts like securities. The contract includes defined parameters that are established at execution with the Contract buyer and are set for the life of the agreement. These parameters include the term of the contract, effective date, maturity date, the home price index, attachment point to the index, and detachment point to the index.

The term “HVA™ note” (also referred to as the “note”) as used herein is the security that HVA™ note investors (also referred to as protection sellers) buy to gain exposure to home prices and potentially earn returns commensurate with the risk the Note creates. Note investors may also sell or trade the note. The note includes defined parameters that are established at its original issue with the initial note investor and are set for the life of the security. These parameters include the term of the note, effective date, maturity date, periodicity, day-count convention, level of interest payments, the home price index, attachment point to the index and detachment to the index.

The term “HVA™ contract buyer” (also referred to as “protection buyer” or “HVA™ contract owner”) as used herein is the entity that directly or indirectly purchases the HVA™ contract primarily or through the secondary market and receives the benefit of protection to systemic home price risk stipulated by the terms of an HVA™ contract.

The term “HVA™ note investor” (also referred to as “protection seller” or “HVA™ note owner”) as used herein is the entity that invests in an HVA™ note at primary issue or through the secondary market.

The term “Protection Amount” (also known as “contract coverage”, “protection”, “coverage”, or “investor note principal”, or “investor note notional”) as used herein is the difference between the index attachment and detachment points when expressing the Protection Amount as a function of home value in the HVA™ Contract. As a notional value (e.g., dollar value), the Protection Amount could equal the product of the Home Value and the difference between the Detach and Attach values (e.g., Protection Amount=Home Value×(Detach-Attach)). At maturity of the Contract, how much of the protection amount will be paid to the Contract owner will be dictated by the value of the reference home price index and corresponding change from its starting value.

The term “HVA™ Note principal” (also known as “Investor Note notional”) as used herein is the difference between the index attachment and detachment points when expressing the HVA™ Note principal as a function of home value in the HVA™ Note. As a notional value (e.g., dollar value), the HVA™ Note principal could equal the product of the Home Value and the difference between the Detach and Attach values (e.g., Protection Amount=Home Value×(Detach-Attach)). At maturity of the Note, how much of the principal amount will be repaid to the Note Investor will be dictated by the value of the reference home price index and corresponding change at the Note maturity from its starting value.

The term “HVA™ Contract Origination” (also referred to as “HVA™ Contract Execution” or “HVA™ Contract Initiation”) as used herein is the point at which the Contract provisions are locked in with the Contract owner.

The term “HVA™ Contract Maturity” as used herein is the point at which the Contract ends. This is also the point at which the home price index value and change in the index are assessed. Based on the change in the index relative to the attachment and detachment points, the calculated amount of protection coverage, if any, will be paid to the Contract owner.

The term “Systemic Risks” (also referred to as “Systemic Price Risk”) as used herein are any risks that can collapse an entire market or market segment. They are risks that are pervasive and un-diversifiable as opposed to discrete risks that can be isolated and addressed. In residential real estate, Systemic Risks that impact the value of real estate overall include, but are not limited to, interest rates, supply of real estate, appraisal accuracy, availability of credit, affordability subsidies (e.g. tax deductions, access to loans via GSEs, tax credit), etc.

The term “Residential Real Estate Systemic Price Risks” (also referred to as “Home Value Risks”) as used herein are any risks that uniformly impact all residential real estate values or prices.

The term “Home Price Index” (also referred to as “HPI” or “index”) as used herein is an index that measures home price levels. There are different methods to determine the index value. One common method is through a weighted, repeat sales method. The HPIs can be created to represent different categories of homes based on characteristics such as geography, size, property type, mortgage type, etc.

The term “Home” (also intended to represent residential real estate exposure) generally refers to a house, apartment or other shelter that is the usual residence of a person, family or household and/or the exposure to residential real estate price risk a protection buyer has and would like to mitigate.

The present disclosure illustrates systems and methods by which a capital market investor takes risk of a downturn in national or regional real estate markets through a fully-funded index-linked note, while simultaneously providing contractual protection to institutions and consumers against drops in home prices due to the systemic pressures that drive home price index levels.

### DESCRIPTION OF THE DRAWINGS

These and other advantages of the present invention will be readily understood with reference to the following specification and attached drawings wherein:

FIG. 1a is diagram reflecting the basic sources of risk typically considered in residential real estate;

FIG. 1b is a block diagram representing a simplified HVA™ scenario;

FIG. 2a is a block diagram representing the basic mechanics of the HVA™ system;

FIG. 2b is a block diagram representing an overview of the HVA™ system in operation;

FIG. 3a is a hypothetical comparative HVA™ hedge graphic of home values without HVA;

FIG. 3b is a hypothetical comparative HVA™ hedge graphic of home values with HVA;

FIG. 4 is a chart illustrating the importance of stabilizing the real estate loan securitization market;

FIG. 5 is a block diagram illustrating changes in the real estate loan securitization market through a comparison of two similar residential real estate loan portfolios separated by time of origination;

FIG. 6a is a flow chart depicting the buying/selling market structure of an HVA™ system;

FIG. 6b is a flow diagram of a protection buyer contract purchase;

FIG. 7 is a block diagram depicting a computer network capable of operating the HVA™ methods;

FIG. 8 is a flow diagram exhibiting the legal and financial structure of an investment fund which acts as an HVA™, or PVA, investor, while showing the interactions between the various investors, brokers and other transaction parties; and

FIG. 9 is a yield composition of the HVA™ system.

### DETAILED DESCRIPTION

Preferred embodiments of the present invention will be described hereinbelow with reference to the accompanying drawings. In the following description, well-known functions or constructions are not described in detail because they would obscure the invention in unnecessary detail.

The presently preferred embodiments facilitate transference of systemic home price risk from those ill-prepared to hold it to those positioned to accept it. This may be accomplished using a transparent and accessible approach called the Home Value Assurance™ (“HVA™”) system, or HVA™ product. HVA™ is a process by which a capital market investor takes risk of a downturn in national or regional real estate markets through a fully-funded index linked note, while simultaneously providing contractual protection to consumers and institutions against drops in home prices due to the systemic pressures that drive index levels. A primary advantage of HVA™ is to facilitate transference of systemic home price risk from those ill-prepared to hold it (institutions and consumers) to those positioned to accept it (capital market investors). HVA™ is a unique and ideal product in a market whose maximum potential settlement value (defined at maturity) may be fully funded with a third-party custodian during the life of the contract.

The HVA™ System is structured to absorb systemic losses through, for example, facilitating true transference of home price risk from a home seller to an HVA™ Note investor buyer by isolating non-home price risks from both the home buyer and home seller. Such an arrangement yields a fully-funded system because there is no unfunded, under-reserved promise of protection, or variable collateral that can result when relying on an insurance company or derivative counterparty. For example, if a buyer of HVA™ specifies coverage for $100,000 of protection, $100,000 will be held in reserve with a custodian, a 1-to-1 ratio of risk to capital. HVA™, through its link to a real estate price index, isolates the systemic price risk away from the specific risks associated with one or more real estate-related investments.

Typically, a bank, a mortgage insurance company and a consumer share an interest and ability to control the specific risks associated with their real estate investment. Banks and PMI companies invest heavily in proper underwriting and analysis of specific borrowers and homeowners are heavily invested in maintaining their unique properties, but not until the creation of HVA™ were any of these parties able to hedge themselves against the systemic risk of home price variation. HVA™ is a viable hedging process that may facilitate capital relief, enhance asset disposition strategies, promote market stability and restore confidence in home values for both institutions and consumers.

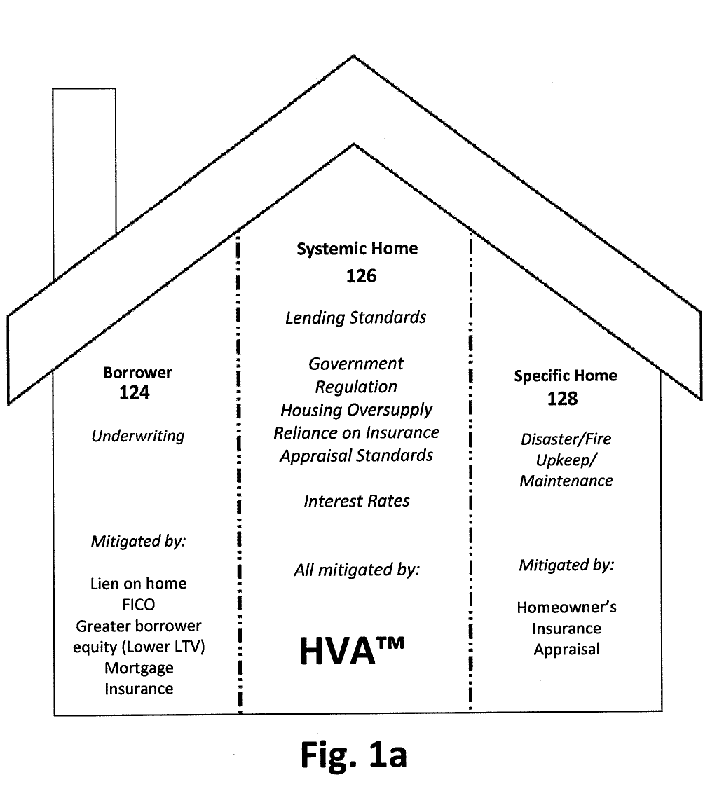

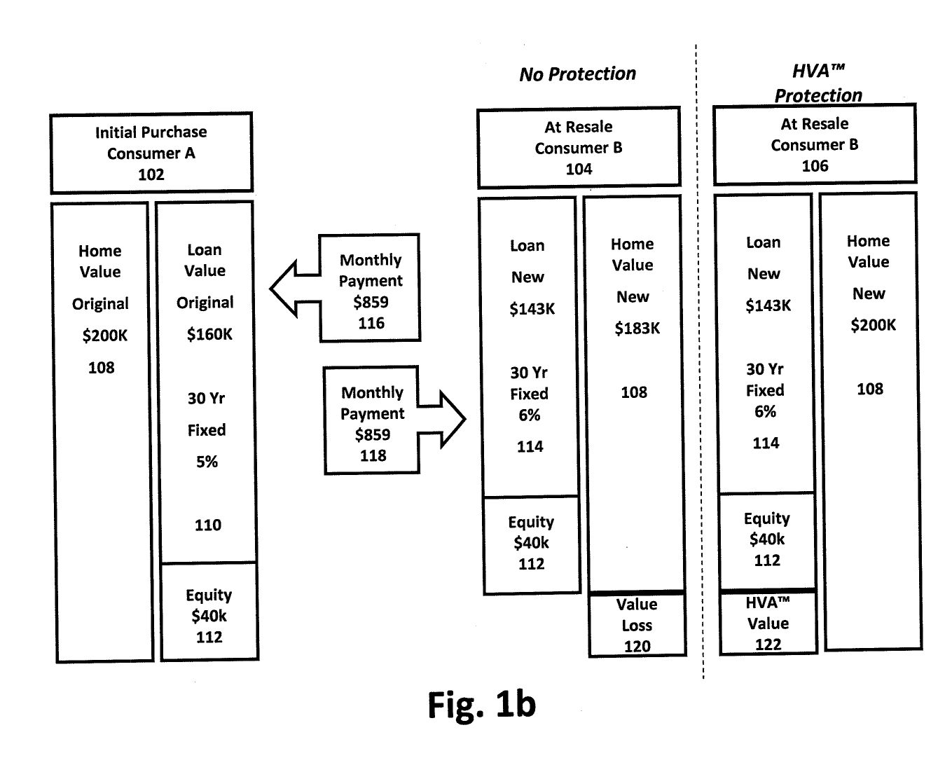

FIG. 1a illustrates the basic sources of risk typically considered in residential real estate. As seen in the figure, financial institutions that lend money for residential real estate are subject to three primary sources of risk. Credit risks attributable to individual borrower (1) and fluctuations in home value due to specific influences (2) and systemic influences (3). The first two risks have existing methods of mitigation. For example, the Borrower risk 124 (e.g., underwriting) is typically mitigated by sound due diligence on the borrower and their credit history, a lien on the property, greater borrower equity (lower LTV) and mortgage insurance. The specific home risk 128 (e.g., disaster/fire, upkeep/maintenance) is typically mitigated by, for example, homeowner's insurance and appraisal. Unfortunately for the financial institutions, the third risk, systemic home price 126, had been previously unmitigated and a substantial risk to lenders. Systemic home price risks are a result of, for example, government regulation, housing oversupply, reliance on insurance, appraisal standards and interest rates. The HVA™ system seeks to mitigate these and other systemic home risks.

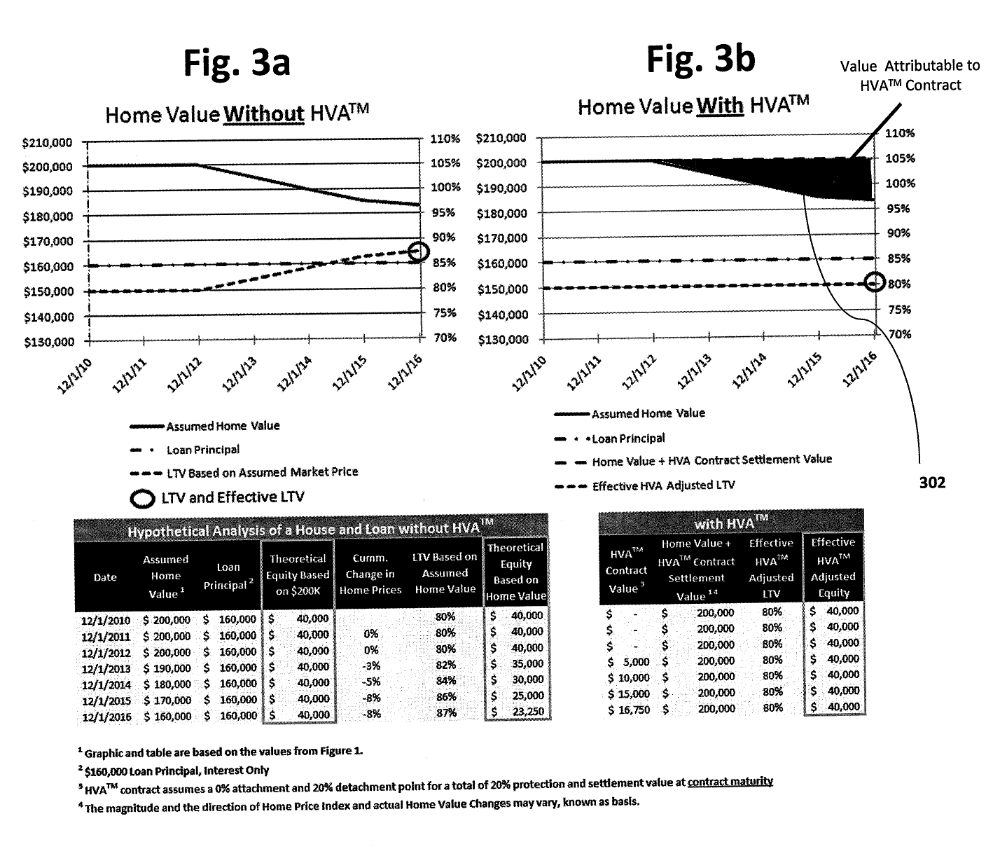

Referring now to FIGS. 1b, 3a and 3b, a simplified HVA™ scenario is depicted. This example presumes any potential homebuyer is limited to a monthly debt service of $859 and has access to $40,000 for the purpose of financing the equity portion 112 of the home purchase 108. Consumer A initially purchases 102 a home for $200,000 108 utilizing both his/her equity monies 112 and a fixed rate 30 year amortizing loan in the amount of $160,000 110. A 5 percent annual interest rate on the $160,000 loan leads to an $859 monthly mortgage payment 116.

For the purpose of this example, prevailing interest rates are increased in the future, forcing prospective homebuyers to pay a 6 percent fixed rate for the same 30-year amortizing loan 114. The monthly payment constraint of $859 reduces the size of the available loan to a future buyer in the higher interest rate environment. Thus, at resale 104, Consumer B may only borrow $143,250 to augment his/her $40,000 of equity 112 to purchase Consumer A′s home. A maximum sales price of $183,250 of Consumer A′s home infers an 8.4% drop in the home's market value and 41.9% reduction of Consumer A′s home equity value, assuming all other price influencing factors remain constant.

However, if at resale, Consumer A owned an HVA™ contract with parameters that afforded protection of an immediate decline in home prices originated when they bought the home 102, then the value of that contract 122 (see FIG. 3b) would increase as losses 120 mount due to reduced purchasing power due to the systemic pressure of an increase in rates. In essence, properly structured HVA™ Contracts offset losses due to the negative pressure on home prices caused by rising interest rates by increasing contract owner's purchasing power.

The HVA™ System is an important tool for both traditional homeowners and entities that originate, sell or purchase loans. Generally speaking, to buy a loan is to make a loan, and the private market is saturated with investors seeking to capitalize on the forced selling of bank assets. This is a healthy process of realizing losses, cleaning bank balance sheets and promoting the flow of capital, which ultimately leads to new loan origination. To the extent more investors are willing to purchase loans, primary lenders may be able to expand their new origination business sooner. HVA™ may provide loan buyers with added protection they need to aggressively bid loan portfolios that simultaneously diminish bank losses through higher sale prices.

For example, a simple static loan liquidation business model is depicted in Table 1.

TABLE 1

| Loan Seller Perspective | | Loan Buyer Perspective | |
|---|---|---|---|
| 90% | Current Home Value- | 76.5% | Presumed Home |
| | Appraised | | Value at Future |
| | | | Liquidation Event |
| −7% | Foreclosure Discount | −7% | Foreclosure Discount |
| −3% | Servicer Advances | −3% | Servicer Advances |
| −4% | Maintenance Costs | −4% | Maintenance Costs |
| −6% | Broker Commission | −6% | Broker Commission |
| −3% | Legal Fees | −3% | Legal Fees |
| 67.0% | Current Home Value | 53.5% | Current Home Value |
| | Net FCL Fees | | Net FCL Fees |
| ÷70% | Original Loan-to-Value | ÷70% | Original Loan-to-Value |
| 95.7% | Percent of loan balance | 76.4% | Percent of loan balance |
| | is the seller | | is the buyer |
| | asking price | | offering price |

When loan purchasers consider the time required to foreclose and sell a property, they may be concerned about potential depreciation of the home value during that time frame. The example loan buyer presumes a 15% drop from the current appraised value, as exhibited by the trend of comparable home sales leading up to the liquidation date; this leads to a wide gap between the bid and offer price for the loan that prevents the execution of a transaction.

For example, a simple static loan liquidation business model is depicted in Table 2 revised to include implementation of HVA™ to offset home depreciation. To alleviate the Loan Buyer's concerns, the Loan Seller purchases an HVA™ Contract on behalf of the buyer for an upfront price of 2.7 percent of the home's original appraised value. In conjunction with an additional 2.6 percent seller cash concession at the sale of the loan, the Loan Buyer is immunized from a drop in the home's value of 15% of the current appraised value, due to systemic shocks, resulting in the final sale price and the Buyer's final liquidation proceeds in equivalence. This example assumes a 5% Attachment point and 15% detachment point, thus current home value at liquidation is 15% less than appraised value and HVA Contract value is 10% of appraised value.

TABLE 2

| A Compromised | | Loan Buyer | |
|---|---|---|---|
| Price Calculation | | Exposure & Protection | |
| 90% | Current Home Value- | 76.5% | Home Value at Future |
| | Appraised | | Liquidation Date |
| −7% | Foreclosure Discount | −7% | Foreclosure Discount |
| −3% | Servicer Advances | −3% | Servicer Advances |
| −4% | Maintenance Costs | −4% | Maintenance Costs |
| −6% | Broker Commission | −6% | Broker Commission |
| −3% | Legal Fees | −3% | Legal Fees |
| −2.7% | Cost for HVA ™ | +9% | HVATM Contract Value |
| 64.3% | Current Home Value | 62.5% | Home Value Net FCL |
| | Net FCL Fees | | Fees + HVA ™ value |
| ÷70% | Original Loan-to-Value | ÷70% | Original Loan-to-Value |
| 91.9% | Percent of loan | 89.3% | Percent of loan |
| | balance is the | | balance is the |
| | seller asking price | | buyer offering price |
| −2.6% | Seller Price Concession | | |
| 89.3% | Percent of loan balance | | |
| | is the Actual Sale Price | | |

As seen in Table 2, the HVA™ process has facilitated a transaction by compressing the bid-offer margin in the loan price and, in this example, the utilization of HVA™ allows the loan seller to concede a minimal one third of the original bid-offer margin to the loan buyer.

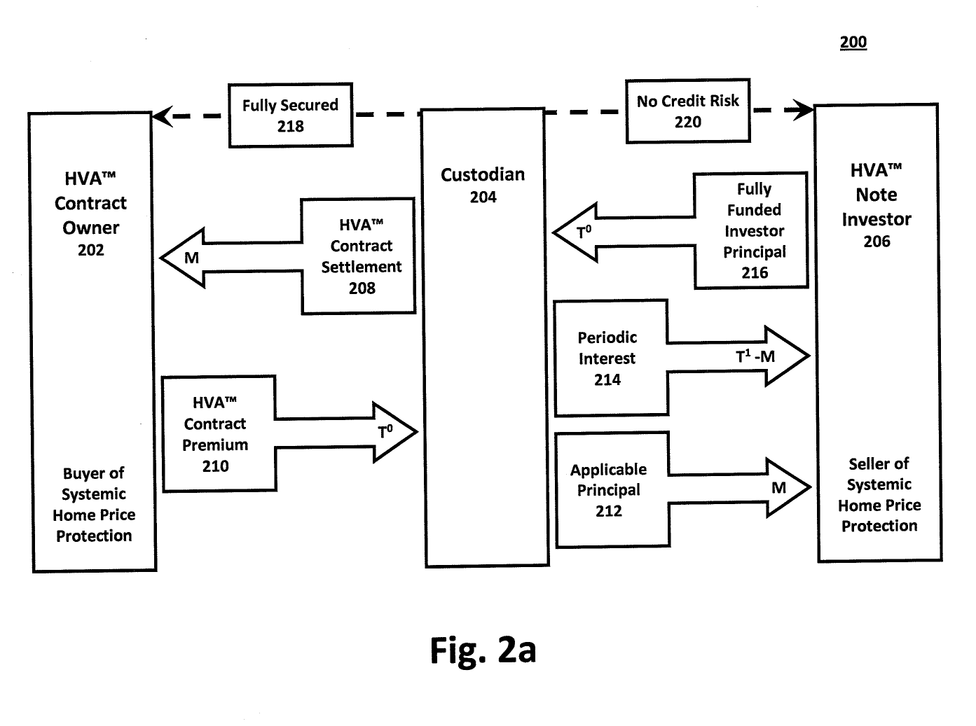

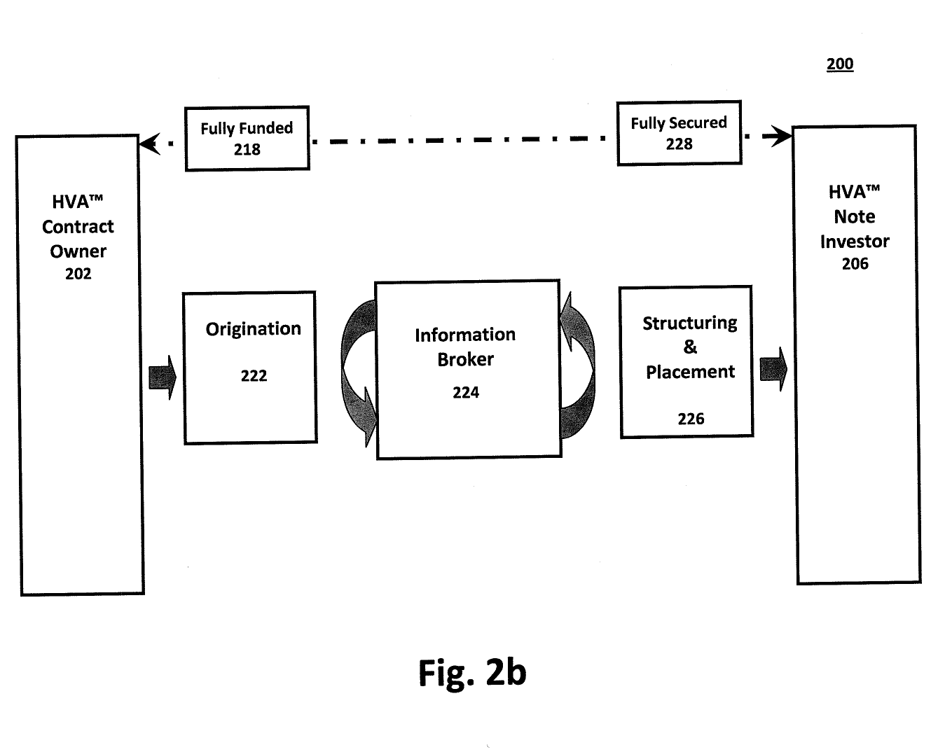

Referring now to FIG. 2a, the basic mechanics of the HVA™ system are shown. The HVA™ Contract Premium 210 is the full-term contract premium payment, less fees, deposited with the custodian upfront at origination (T⁰). The value of the home, or property, as perceived by the protection buyer, is a factor in a protection buyer deciding the dollar amount of protection desired, i.e., the investor principal 216 deposited at initiation. The larger the protection amount, or investor principal, the larger the premium required from the protection buyer, holding constant the other factors that influence the premium. Therefore, the value of the home, or property, influences the amount of the premium, but is not the sole driver, nor necessarily the most important driver. For example, one contract owner may want to protect 10% of the value of a $1 million home using a 0% attachment point and 10% detachment point to an index (to be described below), whereas another contract owner may want to protect 100% of the value of a $100,000 home using a 0% attachment point and 100% detachment point to another index. Both owners would require $100,000 of investor principal, and depending on the risks associated with those choices of indices, attachment and detachment points, could end up paying the exact same premium amount. Specifically, the premium payment corresponds to the present value of: (i) all (or most) of the upfront and ongoing transaction expenses associated with the HVA™ Process, and (ii) the Note Investor's required yield margin over the collateral securities rate of return (in the preferred embodiment, a “risk-free” rate corresponding to Treasury collateral securities but other collateral and rates could be used). Generally, the yield of the collateral securities influences the upfront premium payment 210 from the contract owner 202. In normal circumstances, the Contract Premium may be a function of the contract owner's home or asset value either: (i) directly (a homeowner buying protection against a drop in price for his/her home), (ii) indirectly (e.g., a lender buying protection against loan collateral devaluation), or (iii) not at all (a naked short sale of some price index). In case (iii), a hedge fund manager may need to allocate 5% of his portfolio into a sector not already invested, i.e., real estate, but since he has negative feelings about the sector, he may want to short sell it. The manager may have no current investment position in real estate, so the purchase of protection is not strictly a hedge against real estate exposures but simply a portfolio diversification strategy. The HVA™ Process can allow a manager to accomplish such a strategy. Other products, such as credit default swaps (“CDS”), have been used historically for both hedging and diversification strategies. Regardless of HVA™ Contract owner's purpose, the upfront HVA™ Contract Premium 210 may come from an intermediary on behalf of the HVA™ Contract Owner 202.

As seen in FIG. 2a, the HVA™ Note Investor 206 provides the fully-funded investor principal 216 to the custodian 204 at contract initiation. The investor principal corresponds to the notional amount of protection (coverage) required by one or more of the contract owners against declines in a specified price index, e.g., one or more selected real estate indices. The Periodic Interest 214 serves as a sole source of compensation to the HVA™ Note Investor such that the expected economic return is in line with his/her assessment of the risks involved in making such an investment.

In FIG. 2a, the HVA™ Contract settlement amount 208 comprises the settlement value of the HVA™ Contract at maturity. The settlement value at maturity is a full or partial percentage of the fully-funded investor principal amount as calculated by the calculation agent, preferably the custodian, based on the HVA™ Contract's agreed upon attachment and detachment points to the referenced real estate index and that index's value as computed at contract origination (T⁰) and at maturity (M). The main role of the custodian 204 is to hold the collateral securities in a trust and disburse funds between HVA™ Contract owners 202 and Note investors 206, including, for example, applicable principal 212 at maturity, periodic interest 214 at times between initiation and maturity, HVA™ Contract settlement 208, HVA™ Contract premiums 210, and HVA™ Note investor principal 216. The custodian 204 will typically invest the contract premiums 210 (net expenses) plus the investor principal 216 in collateral securities, preferably risk-free Treasury Notes, Bills, Bonds, Strips, etc., whose payment stream(s) substantially match(es) those required in aggregate by the HVA™ Note investor 206, HVA™ Contract owner 202, and any other transaction parties (e.g., the custodian 204, licensing agents, etc.), over the duration of the contract.

HVA™ Contract settlement payments 208 are not strictly tied to the contract owner's asset (e.g., real estate) values, but to a price index (e.g., one or more real estate indices or other representation of the real estate market). The Contract owner 202 is paid settlement amounts 208 preferably corresponding to a drop in the predetermined price index (or indices) between the Contract Origination T⁰ and contract maturity M that are covered by the Note investor principal 216, as provided at origination by the attachment and detachment point selections. In certain embodiments, the index may determine the payment of Note Investor principal to the Contract owner or back to the Investor. The real estate price index is an objective statistical metric (e.g., an average, median, quantile, etc.) describing any number of property valuations, whether sale prices, appraisals or both. The choice of what properties should be in the index, i.e., what index is chosen, is a decision preferably made by the Contract owner 202 and Note investor 206. As an extreme example, an individual wanting to protect his particular home value may construct an index whose sole constituent property is that specific property, i.e., an index of one house. It could be an ideal hedge from the individual's perspective, but the likelihood that an investor would be willing to sell that protection at an economically viable level would be very low due to the extreme level of specific risk. Typically, investors may insist on selling protection based on a national housing index because of its lower volatility, and hence the protection could be offered relatively inexpensively. Although the lower price of a national index protection scheme may entice the protection buyer, he/she may be skeptical that the value of his/her house will fluctuate in sync with the nation as a whole, hence he/she may propose a more focused index, e.g., a regional index, such as the Charlotte-MSA price index, that balances price and protection specificity. This is the typical market-making process, balancing the owner's demand for a perfect hedge with the investor's supply of protection.

Referring now to FIG. 2b, an overview of the HVA™ System 200 the HVA™ System is comprised of protection buyers and sellers whose economic interests and integrity of the transaction are maintained by the assets held in trust by the custodian. One side of the HVA™ system comprises HVA™ Contract Owners 202, which generally includes one or more owners seeking protection or concession to facilitate liquidity. HVA™ Contract Owners 202 may include, but are not limited to: banks, home buyers, home owners, home sellers, builders, developers and portfolio managers. The origination 222 of the contract could be performed by one of a number of financial institutions or real estate entities in a position to offer protection to owners and/or potential HVA™ Contract Owners 202. Originators 222 may include, for example, banks, mortgage originators and real estate brokers. Because the HVA™ Contracts are fully funded 218, the Originators 222 will coordinate warehouse lines if the Note Investors have not been sourced. Ultimately, the HVA™ Contracts may be grouped together and placed in lots, with common characteristics such as indices, attachment and detachment points, maturities, etc.

The other side of the HVA™ System 200 includes one or more HVA™ Note Investors 206. HVA™ Note Investors 206 are, generally speaking, investors seeking to create investment exposure to residential real estate and portfolio allocations for favorable relative value versus other fixed income investments. Investors may include, for example, banks, institutional and retail note buyers, governments, funds, insurance companies and/or exchange-traded fund (“ETFs”)/unit investment trusts (“UITs”). The HVA™ Note investments are fully collateralized 204 and impose no credit risk. They are typically available from structuring and placement 226 institutions such as investment banks. At the heart of the HVA™ System 200 is an Information Broker 224 (e.g., Lighthouse Group International (“LGI”)) that may work directly, or with partner institutions, to create a marketplace where a potential HVA™ Contract Owner 202 can be matched with an HVA™ Note Investor 206. Information Broker 224 and/or Origination 222 may leverage the vast existing network of real estate-related service providers, both consumer and institution oriented, to facilitate the awareness and use of HVA™. Originator 224 may target buyer and seller markets exhibiting the greatest need for liquidity and highest risk-adjusted yields, analyzing real estate risk and creating the vehicles that promote transference of that risk.

Referring now to FIGS. 3a and 3b, hypothetical comparative graphics depicting the effect of the HVA™ hedge, FIGS. 3a and 3b depict the evolution of the loan to value (“LTV”) ratio for a borrower and lender during a period of time when home prices are dropping. FIG. 3a depicts the control scenario, no use of HVA™, while FIG. 3b depicts a scenario in which HVA™ has been purchased, either by the borrower or the lender. The graphs illustrate the protection an HVA™ Contract can supply to a lender and homeowner as a function of time and home price depreciation. As seen in FIG. 3b, if home prices decline due to systemic pressures, the HVA™ Contract may increase in value by a related amount (subject to the HVA™ Contract's predetermined attachment and detachment points) and supply the Contract owner, whether the borrower or lender, with an asset that may maintain the borrower's purchasing power, or maintain a lender's required LTV cushion. The shaded triangular region bounded by the Home Value, HVA™ Contract Settlement Value and Assumed Home Value plots 302 (see also, FIG. 1, 122 and FIG. 2, 208) represents the value attributable to the HVA™ contract. Widespread use of the HVA™ process would prevent future systemic failures in the residential real estate market of the type recently experienced, and made evident by, but not limited to, personal bankruptcies, strategic defaults, financial institution pressure for costly mortgage modifications and mortgage insurance failures.

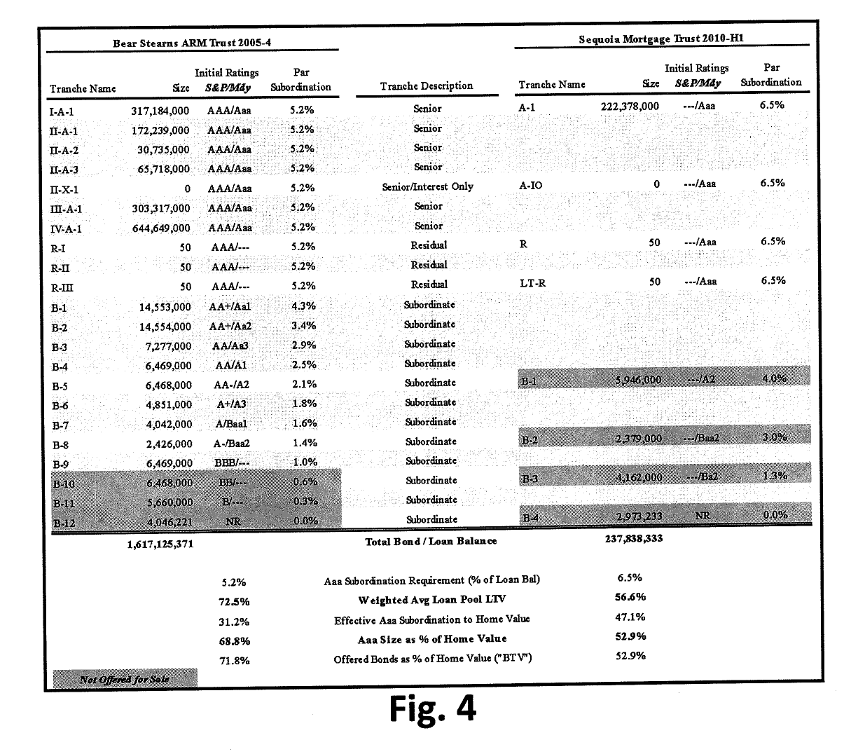

The importance of the HVA™ system can also be deduced from FIG. 4, a chart that illustrates the importance of stabilizing the real estate loan securitization market. The failure of securitization market participants to accurately gauge risk was the catalyst for the stoppage of the entire mortgage origination process. By measuring the failures and addressing them, HVA™ will provide a basis for a renewed trust from securitization market investors and promote viable access to credit. The table in FIG. 4 details elements important in understanding where the private securitization market was, where it is now and what needs to change for a return to an appropriate lending volume. New normal lending should be viewed as loans and credit extensions that are structured to reflect terms, conditions and pricing commensurate with the collateral and risk profiles of the borrowers. Formerly, in the pre-credit crisis era, risks were not properly assessed by lenders, investors or rating agencies and in some instances information was not accurately accumulated or disseminated so that adequate due diligence could be performed. However, in the post credit crisis phase risks may be over exaggerated and due diligence processes are hampered by too conservative a stance. Hence, there is no need to address and validate risks so the markets return to a new normal.

To properly appreciate the differences between 2005, pre credit crisis, and 2010, one must understand that the primary component to a successful and economical securitization is the existence of a large “AAA” rated senior bond(s). Since the senior bond represents such a large portion of the home financing, and carries a lower interest rate than that of the subordinate bonds, changes in either the size or interest rate of the bond(s) have a direct impact on the structure and rates of the home loans being securitized, thus affecting the affordability of homes. Equally important to the size of the bond(s) is that it be salable. The placement agents for the Sequoia Mortgage Trust (“SEMT”) 2010-H1, which held non-Agency, 2010-originated residential mortgage loans, were not able to sell all of the investment grade bonds issued, likely due to highly inefficient pricing resulting from low demand fueled by both investor uncertainty and lack of a second rating agency. Overall, the 2010 transaction lacked the efficient execution of the vintage 2005 deal and set a poor precedent for future transactions.

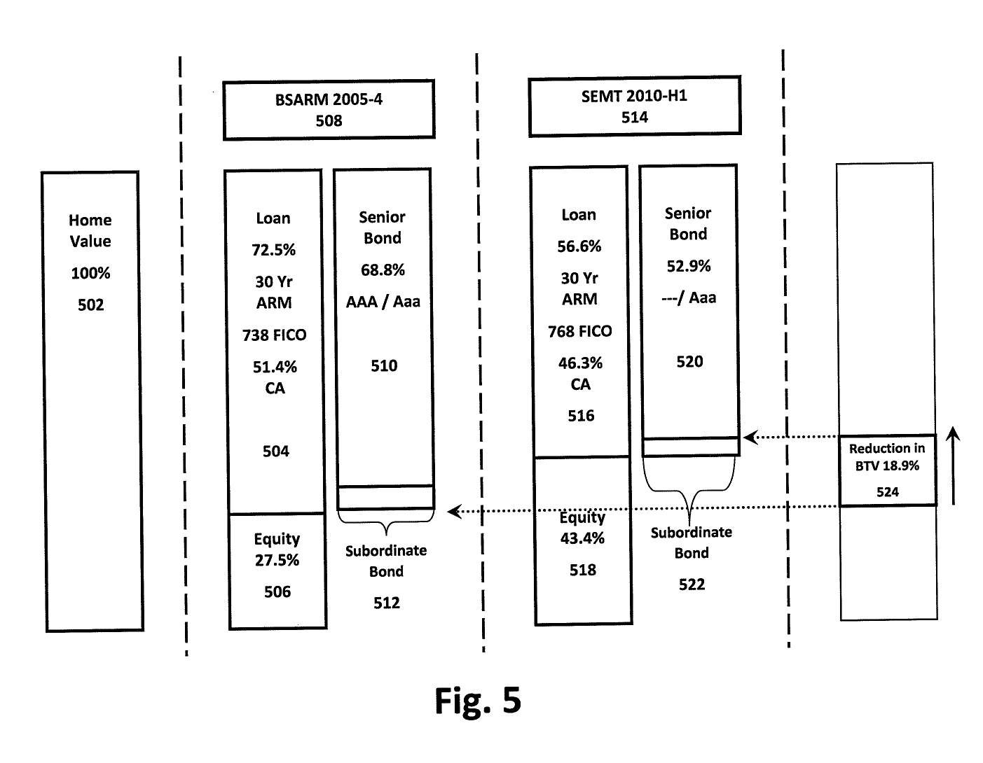

Due in part to decomposing home purchase financing pre and post credit crisis (via private securitization), FIG. 5 illustrates how similar portfolios separated only by time can show drastically different treatment by rating agencies. Over a five-year period, there was an 18.9% reduction in the offered bond value as a percentage of home value (“BTV”) 524. This drastic reduction in bond size is evidence of an “overcorrecting” made by capital market participants who until the advent of HVA™ were forced to assume too conservative positions in their assessments of current real estate market risk. Not only is understating risk a contributor to market volatility but so is overstating risk, and in this market the overstatement of risk is counterproductive to the overall market desire for stabilization. The housing crisis has forced various market participants, namely the rating agencies, to accept house price correlation as a true risk. In the comparison of Bear Stearns Adjustable Rate Mortgage Trust (“BSARM”) 2005-4, which held non-Agency, 2005-originated residential mortgage loans, 508 and SEMT 2010-H1 514, certain characteristics that are major influences on bond ratings can be held constant (e.g., borrower credit scores, geographic concentration, loan amortization, etc.), while examining the one important factor that is different, the LTV ratio of the loan pool. The newer loan pool exhibits a 22% lower LTV than the older pool, yet the treatment by Moody's Investors Service (“Moody's”) suggests that both pools exhibit the same probability of loss. This is evidenced by the near identical subordination levels required for each pool to achieve an Aaa rating from Moody's. Moody's is a credit rating agency that performs international financial research and analysis on commercial and government entities. Moody's also ranks the creditworthiness of borrowers using a standardized ratings scale while holding a 40% share in the world credit rating market, as does its main rival, Standard & Poor's.

To quantify the changed view by Moody's, one can model the likelihood of the portfolio's home values dropping below the aggregate loan amount as one would in determining the number of “heads” in successive coin tosses, by using the Binomial Probability Mass Function. A first step in the quantification process is to identify what the Aaa rating implies to a bond that carries that rating. Moody's has defined its Aaa rating to convey a specific probability of default for a given maturity, and in this example we have chosen the five-year Aaa value. Secondly, define the two parameters needed to specify the Binomial Model, N and P. For this purpose, we define N to be the number of statistically independent segments the loan portfolio is comprised of where home values within a segment are perfectly correlated and home values between segments are completely independent. P is the probability that home prices within a segment drop to a level below the segment's aggregate loan balance, a simple definition of a loss event. As summarized in the comparison of mortgage-backed notes shown in Table 3, assuming that the BSARM 2005-4 508 loan portfolio was comprised of 100 non-correlated segments, it is a simple exercise to establish P, such that the probability the BSARM 2005-4 508 portfolio experiences cumulative home value drops less than or equal to the 31.2 percent Aaa subordination level 506 and 512 such that the five-year Aaa threshold likelihood from Moody's is not violated.

TABLE 3
Test of Correlation Increase in Credit Models

| | |
|---|---|
| BSARM 2005-4 | SEMT 2010-H1 |

| | | |
|---|---|---|
| 31.2% | Aaa Subordination | 47.1% |
| | to Home Value | |
| 200 | N* | 34 |

*Assumptions for Loss Likelihood

The likelihood of the portfolio's home values dropping below the loan amount follows a Binomial Probability Mass Function, Binomial (N,P) where N is the number of statistically independent segments within the loan pool and P is the probability home values within a segment drop below the aggregate loan amounts. The Default Probability, P, is 19.7% as derived from the BSARM 2005-4 508 Moody's treatment, while Default Likelihood for a five-year Aaa Bond is 0.0029%.

To compute N for the SEMT 2010-H1 portfolio 514, which is used in conjunction with the P computed from BSARM 2005-4 508, leads to at least a 47.1% subordination to home value requirement to achieve an Aaa rating. The change in the value of N from 2005 to 2010 quantifies the change in Moody's assumed correlation in home prices. From an arbitrary starting point of 200 in 2005, the 2010 transaction implies a value of only 34. This 83% drop in the assumed number independent segments, a measure of portfolio diversity, is directly attributable to the recognition by Moody's of the systemic risk of home prices. For future transactions, both investors and rating agencies will favor the inclusion of HVA™ contracts as hedging instruments to create a truly diversified portfolio deserving of a better, more efficient securitization.

It is worth noting that the gross reduction in BTV of approximately 19% from 2005 to 2010, visualized in FIG. 5, is directly analogous to the initial 19% bid-offer margin in Table 1. Not coincidentally the method of increasing BTV closer to historical norms is the same as required for narrowing the bid-offer margin in loan pool sales transactions, the use of HVA. In this case, the bond buyers are the loan buyers looking to pay according to the risks they are taking. A combination of investor education and rating agency acceptance of the HVA™ solution to systemic risk will equate to a closing of the historical-current BTV gap, and again will start the private securitization engine that once fueled a stable real estate market, and restore “new normal” lending.

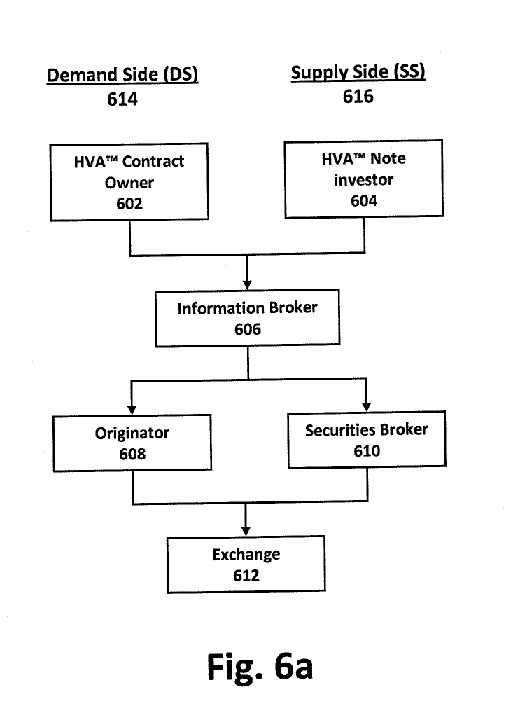

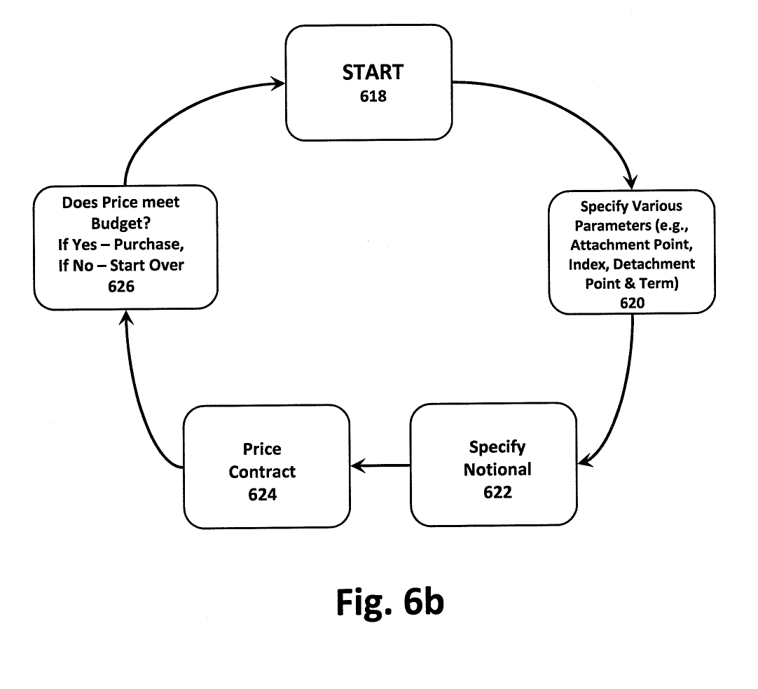

FIG. 6a depicts the basic market making process of FIGS. 2a and 2b in greater detail where a number of entities work in concert to establish a market having a demand side (DS) 614 and supply side (SS) 616. The system allows for HVA™ Contract Owner 602 and a HVA™ Note investor 604 to trade contracts or notes via a number of entities. The primary entities may include, for example, an Information Broker 606 (authorized reseller of Note and Contract pricing and analytics services and products, (e.g., Bloomberg, Reuters, Markit, Intex, LGI, etc.)), an Originator 608 (e.g., an authorized licensing agent and re-seller of Contracts, i.e., LGI), a Securities Broker 610 (e.g., authorized distribution agent for Notes), and an Exchange 612, typically an organized marketplace for the trading of Notes and Contracts, (e.g., NYSE, NASDAQ, CME, CBOT, and other clearinghouses and trading platforms the SEC and CFTC are developing to lend greater security and transparency in the OTC derivatives markets). Other suitable specific entities such as regulators, trade groups, industry groups and general market participants that may or may not fall into the primary categories may also be involved, including, but not limited to: Real Estate Broker; Mortgage Broker; Home Builder; Retail; Corps/Trusts; FDIC/OCC/Treasury; FHLMC/FNMA/GNMA; HUD/FHA/VA/FSA; FHFA/NCUA/FED; SEC/FINRA; Rating Agencies/FASB; State HFAs; Basel Committee; Commercial Banks; Investment Banks; Credit Unions; PMI Companies; Securities Funds; Property Funds; Specialty Lenders; Index Provider; Custodian/Trustee; Accountants; and Attorneys.

To initiate a transaction on the demand side 614, an Originator 608 may approach a Protection Buyer 602 about a Contract demand or supply. The protection buyer 602 may establish a Contract demand through internal analysis and external support via Originator 608 and Information Broker 606. Contract parameters may include, for example: which index is used to track asset values (singular or portfolio); the term of the protection; the notional or amount of protection required; the attachment point (e.g., for how much index decline is acceptable before protection is provided) and the detachment point (e.g., how much index decline beyond that attachment point is protection necessary).

To initiate a transaction on the supply side 616, Securities Broker 610 may also approach Protection Seller 604 about Note demand or supply, often via the Information Broker 606. Protection Seller 604 establishes Note demand through internal analysis and external support via Securities Broker 610 and Information Broker 606. Note parameters may include: risk of index decline beyond the attachment point; period of time or term the investment principal can remain outstanding before being returned; required yield based on risk, term and periodicity (e.g., how often must interest payments be made over the term of the Note, i.e. monthly, quarterly, etc.); profile and construction of the Note collateral held in trust by the custodian. Securities Broker 610 may then establish Note yield and buy or sell a Note from or to a Protection Seller 604.

An Information Broker 606 may be approached by a Protection Buyer 602, Protection Seller 604, Originator 608 and/or Securities Broker 610 for current and historical Contract and Note data and analytics. In exchange for fees and/or access to transactional data, Information Broker 606 may provide informational services and data. In certain embodiments, the Information Broker 606 may pay licensing fees to another party (i.e., LGI).

As mentioned above, an Originator 608 may approach a Protection Buyer 602 about Contract demand or supply and provide the Protection Buyer 602 with data and analysis via internal processes and Information Broker 606 process to establish a Contract Price. Additionally, the Originator 608 may also sell or buy the Contract to or from a Protection Buyer 602. As with the Information Broker 606, the Originator 608 may pay licensing fees to another party (i.e., LGI) on, for example, a per annum or per Contract sale basis.

A Securities Broker 610 may also directly approach a Protection Seller 604 about Note demand (or supply) and provide Protection Seller 604 with data and analysis via internal processes and Information Broker 606 access. Securities Broker 610 may establish Note Yield and sell/buy a Note to/from a Protection Seller 604. Securities Broker 610 may also pay a licensing fee to another party (e.g., LGI) on, for example, a per annum or per Contract sale basis.

The Exchange 612, or other organized marketplace for the trading of Notes and Contracts, provides an atmosphere where Originators 608 and Securities Brokers 610 may solicit each other for Contracts and Notes that satisfy client needs (e.g., a Protection Buyer 602 or Protection Seller 604). Originators 608 and Securities Brokers 610 may create Contracts and Notes that satisfy client needs (i.e., New Issuance) and new Notes and Contracts are listed on the Exchange 612, or other organized marketplace. Originators 608 and Securities Brokers 610 may then buy/sell Contracts and Notes that satisfy client needs (e.g., Secondary Trading) where the Exchange, or other organized marketplace participants 612 may pay a licensing fee to another party (i.e., LGI) on, for example, a per annum or per Contract sale basis.

FIG. 6b is a flow diagram illustration of a Protection Buyer 602 contract purchase. Once the protection buyer 602 decides to initiate a contract purchase, 618 the buyer specifies 620, for example, the reference index; the term of the protection; the attachment point and the detachment point. The Protection Buyer 602 then indicates the notional or amount of protection referred to as Protection Amount or Contract Coverage required 622 to yield the contract price 624. If the contract price 624 is at or below a predetermined budget value, the purchase is completed. However, if the contract price 624 is greater than a predetermined budget value, the contract is not purchased and the Protection Buyer 602 must start over 618 and adjust his or her parameters.

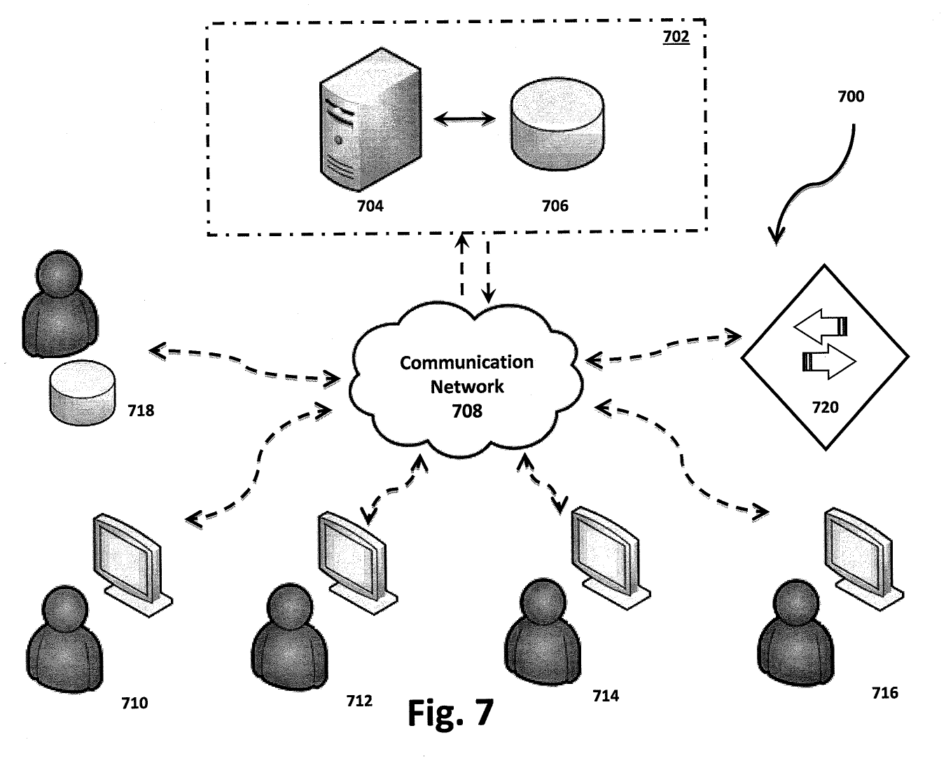

FIG. 7 depicts a computer network 700 capable of operating the HVA™ methods and enabling a number of entities to work in concert to establish a market having a demand side (“DS”) 614 and supply side (“SS”) 616. An example system 700 is shown wherein one or more entities 710, 712, 714, 716 (e.g., Protection Buyer, Protection Seller, Originator, Securities Broker, etc.) and Information Broker 718 may connect to a server system 702 using a communication network 708 (e.g., the Internet). The server system 702 may also be in communication with the exchange 720 via communication network 708. The server system 702 may include one or more servers, each including at least one database 706 and one or more processors 704 capable of running computer source code. The database 706 may be used to store the data from information broker 718 and other data generated by the HVA™ system. The server system 702 may also be in communication with an information broker 718 that may be capable of providing current and historical Contract and Note data, indices and analytics. The information broker 718 may be composed of one or more sources preferably having up-to-date and/or real-time information regarding current and historical Contract and Note data and analytics (e.g., a financial institution, a periodical, a stock market, etc.). In certain embodiments, the server system 702 may further include the exchange 720 and/or be otherwise centrally located.

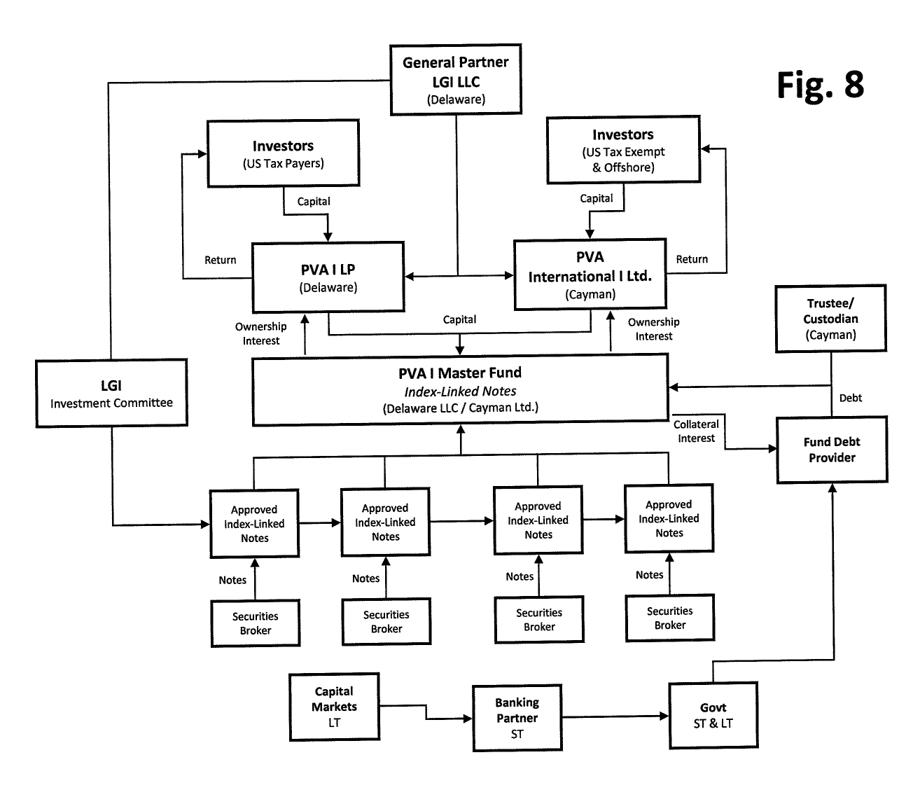

Referring now to FIG. 8, an example flow diagram illustrates the legal and financial structure of an investment fund which acts as an HVA™, or PVA, investor, while showing the interactions between the various investors, brokers and other transaction parties. For example, an investment fund manager, the General Partner, may establish a legal entity with the capability of making nominal investments into any number of HVA™ or PVA notes. Funding for the entity comes from a combination of equity investors (capital), either U.S. tax payers, U.S. tax exempt, offshore entities, or any combination thereof, and Debt Providers (Debt) from the capital markets, banking and/or government community. Raised Capital and Debt are held in trust by the Trustee until such time as the General Partner dictates that such funds be deployed to purchase, or perhaps sell, approved notes. Notes potentially suitable for purchase by the entity are offered to the General Partner by a network of Securities Brokers and subsequently screened by the Investment Committee and other parties as dictated by the entity's investment guidelines prior to making a purchase or sale decision. Upon the fund's maturity, liquidation or upon a pre-determined schedule, Capital and Debt funds are returned by the Trustee to the equity Investors and Debt Providers.

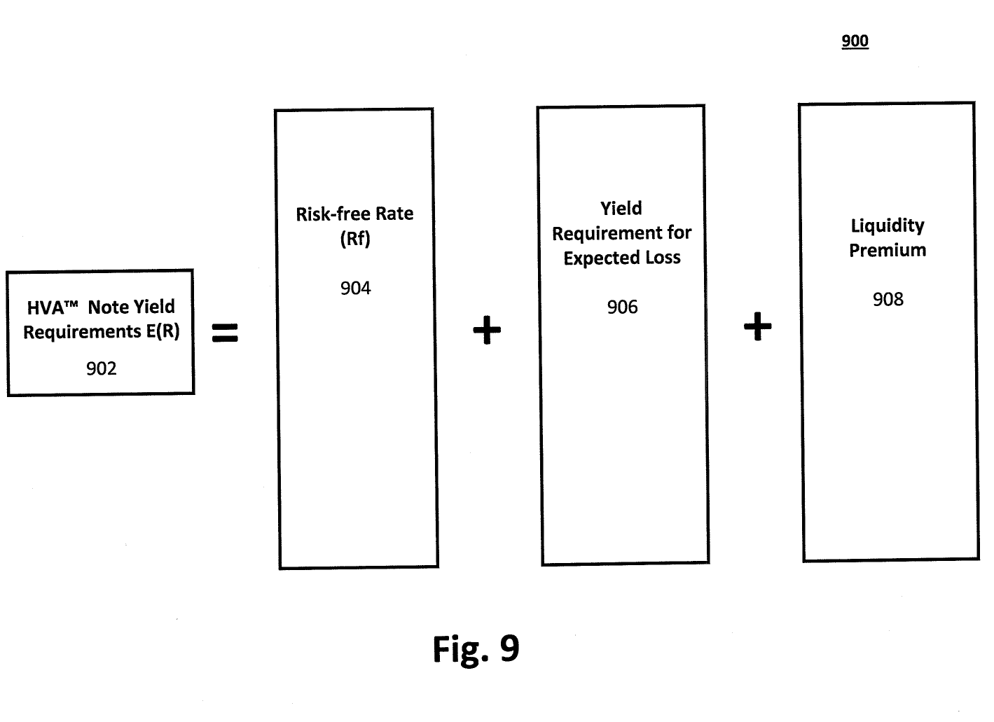

When embracing a new structure, investors should evaluate the risk and return of an investment. HVA™ Notes are no exception to this concept and should incorporate standard elements of real estate oriented fixed income investments and standard valuation criteria. To gauge initial HVA™ Note return requirements, LGI methodically considers the means in which to frame return expectations. HVA™ Notes are uniquely positioned as non-legacy residential real estate exposure and do not expose investors to credit risk. HVA™ Note investors are guaranteed to receive some level of principal back through interest funded to the custodial account. The yield composition 900 of the HVA™ system is depicted in FIG. 9. Generally speaking, the HVA™ Note Yield is based on three main components: (i) the Risk free Rate (Rf) 904 (e.g., Treasury security or other vehicle with maturities that matches the HVA™ note.), (ii) the yield requirement for expected loss 906 (e.g., Historic Framework, Forecasted Values) and (iii) the liquidity premiums extrapolated from securities with similar investor profiles 908 (e.g., real estate investment trust (“REITs”), Residential Mortgage-Backed Security (“RMBS”), Commercial Mortgage-Backed Security (“CMBS”), Government-Sponsored Enterprises (“GSE”), and other classes of fixed income instruments). When considering the liquidity premium 908, one may consider the liquidity premiums required by comparable securities.

The individual components shown in outline or designated by blocks in the attached drawings are all well-known in the financial and computer arts, and their specific construction and operation are not critical to the operation or best mode for carrying out the invention.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions. Furthermore, while the description so far has centered on use in residential applications, it is clear to those of skill in the art that it can equally be applied to other applications, including, for example, commercial real estate.

All U.S. and foreign patent documents, all articles, brochures, and all other published documents discussed above are hereby incorporated by reference into the Detailed Description of the Preferred Embodiment.

What is claimed is:

1. A custodial server system for providing home value assurance (HVA), comprising:
at least one custodial server configured to:
at an HVA contract initiation, receive on behalf of an HVA contract owner a full-term, fully-funded contract premium payment corresponding to a value of the HVA contract owner's home;
at the HVA contract initiation, receive from an HVA note investor a fully-funded investor principal corresponding to the value of the HVA contact owner's home;
after the HVA contract initiation, provide to said HVA note investor periodic interest;
at HVA contract maturity, provide to said HVA contract owner a value corresponding to a change in one or more predetermined real estate indices; and
at HVA contract maturity, provide to said HVA note investor a value corresponding to the change in one or more predetermined real estate indices.

2. The custodial server system according to claim 1, wherein the periodic interest is provided via trust account held by a custodian.

3. The custodial server system according to claim 1, wherein, at HVA contract maturity, the HVA note investor is provided a value corresponding to the investor principal net amounts paid to said HVA contract owner at HVA contract maturity.

4. The custodial server system according to claim 1, wherein the contract premium payment corresponds to a present value of (i) substantially all upfront and ongoing transaction expenses associated with the HVA contract, and (ii) the note investor's yield margin to a collateral securities rate of return.

5. The custodial server system according to claim 3, wherein the collateral securities rate of return corresponds to U.S. Treasury collateral securities.

6. The custodial server system according to claim 1, wherein the contract premium payment corresponds directly to the value of the HVA contact owner's home.

7. The custodial server system according to claim 1, wherein the contract premium payment corresponds indirectly to the value of the HVA contact owner's home.

8. The custodial server system according to claim 1, wherein the full term of the HVA contract is for a fixed, predetermined period of time.

9. The custodial server system according to claim 1, wherein the investor principal corresponds to a nominal amount of protection required by one or more HVA contract owners against declines in the one or more predetermined real estate indices.

10. The custodial server system according to claim 1, wherein the at least one custodial server is also configured to, after HVA contract initiation and before HVA contract maturity, investing (i) the contract premium payments, net expenses, and (ii) the investor principal, in collateral securities.

11. The custodial server system according to claim 9, wherein the collateral securities comprise at least one of: U.S. Treasury obligations or other government securities.

12. The custodial server system according to claim 9, wherein the collateral securities' payment stream(s) match those required contemporaneously by the note investor and the contract owner, in aggregate, over the duration of the HVA contract.

13. The custodial server system according to claim 1, wherein the at least one custodial server is also configured to, after HVA contract initiation and before HVA contract maturity, provide to further transaction parties periodic transactional fees.

14. The custodial server system according to claim 12, wherein the further transaction parties comprise at least one of (i) the custodian, and (ii) one or more licensing agents.

15. The custodial server system according to claim 1, wherein, at HVA contract maturity, the HVA contract owner is provided a value corresponding to a drop in a price index of the one or more predetermined real estate indices, between the contract initiation and the contract maturity, and for predetermined levels of price index declines.

16. The custodial server system according to claim 1, wherein the one or more predetermined real estate indices comprises a real estate index having substantially no inflation component.

17. The custodial server system according to claim 1, wherein the one or more predetermined real estate indices comprises a paired-sale index.

18. The custodial server system according to claim 1, wherein one or more predetermined real estate indices comprises the Case-Shiller Index.

19. The custodial server system according to claim 1, wherein the fully-funded contract premium payment received from the HVA contract owner corresponds to a cash value required to cover HVA note investor yield requirements.

20. The custodial server system according to claim 18, wherein the requirements comprise at least one of: upfront transaction expenses; ongoing transaction expenses; and/or licensing fees.

21. The custodial server system according to claim 1, wherein the fully-funded investor principal received from the HVA note investor corresponds to a cash value required to cover the potential liability of HVA contract losses.

22. The custodial server system according to claim 21, wherein the HVA contract losses comprise at least one of: HVA Protection Amount or HVA Coverage.

23. The custodial server system according to claim 1, wherein the at least one custodial server provides to the HVA note investor an HVA financial instrument having a potential value at maturity corresponding the HVA contract's maximum protection amount.

24. The custodial server system according to claim 22, wherein the HVA financial instrument comprises real estate value risk and substantially no counterparty-credit risk.

25. A method for providing home value assurance (HVA), comprising:
providing at least one custodial server configured to perform the steps:
at an HVA contract initiation, a custodian who holds the trust account receives on behalf of an HVA contract owner a full-term, fully-funded contract premium payment corresponding to a value of the HVA contract owner's desired protection coverage;
at the HVA contract initiation, a custodian who holds the trust account receives from an HVA note investor a fully-funded investor principal corresponding to the value of the HVA contract owner's desired protection coverage and other predefined parameters;
after the HVA contract initiation, a custodian who holds the trust account provides to said HVA note investor predefined contractual payments;
at HVA contract maturity, a custodian who holds the trust account provides to said HVA contract owner a value corresponding to a change according to the predefined contract parameters in one or more predetermined real estate indices; and
at HVA contract maturity, provides to said HVA note investor a value corresponding to the change in one or more predetermined real estate indices.

26. The method according to claim 25, wherein the predefined contractual payments include periodic interest.

27. The method according to claim 25, wherein the other predefined parameters comprise at least one of term and index.

28. A method for creating and trading a fully-funded home-value security contract for real estate property, comprising:
one or more note investors selling a fully-funded home-value security contract to a contract owner who is seeking protection from a decrease in real estate value;
a custodian holding in a trust account and disbursing funds between one or more contract owners and the one or more note investors, wherein fully-funded upfront premium payments come from the one or more contract note owners, either directly or indirectly; and
an exchange marketplace trading the home-value security contracts.

29. The method of claim 28, wherein only real estate value risk is sold to the one or more contract investors, and not counterparty credit risk.

30. The method of claim 28, wherein home-value security contract parameters are configured such that the contract price is at or below a predetermined budget amount.

31. The method of claim 28, wherein a decrease in real estate value is determined using the Case-Shiller Index.

32. The method of claim 28, wherein the contract owner is also the direct or indirect owner of the real estate.

33. The method of claim 28, wherein the note owner is a party who has purchased a home-value security note either directly or indirectly from the owner of the real estate.

34. The method of claim 28, wherein the Contract Owner purchases a home-value contract either directly or indirectly from a Note Investor.

35. The method of claim 28, wherein the home-value security contract has a fixed maturity date.

36. The method of claim 28, wherein the real estate property comprises residential real estate.

37. A method for providing a real estate financial instrument, comprising the steps of:
accessing at least one real estate index that provides one or more values of one or more real estate properties;
establishing a real estate instrument having a first value at a first time and another value at a fixed expiration date of said real estate instrument;
defining a cash-settled payout of said real estate instrument, based upon a change in the value of the index between the first time and the fixed maturity date;
indentifying a seller of the real estate instrument;
indentifying a buyer of the real estate instrument;
marketing the real estate instrument to the seller and the buyer;
selling the real estate instrument through a distribution channel;
clearing and executing the transaction for the real estate instrument through a marketplace structure; and
settling the real estate instrument by making the cash-settled payout to the buyer based upon any change that has occurred in at least one real estate index between two dates, the first of which is on or around the transaction issuance date, the second of which is on or around the transaction maturity date.
